(19) United States
(12) Patent Application Publication
(10) Pub. No.: US 2012/0194907 A1
(43) Pub. Date: Aug. 2, 2012

(54) ANTIGLARE FILM, POLARIZING PLATE, IMAGE DISPLAY, AND METHOD FOR PRODUCING THE ANTIGLARE FILM

(75) Inventors: Masaaki SUZUKI, Shizuoka (JP); Jyunko IBARAKI, Kanagawa (JP); Yoshiki SUGAI, Shizuoka (JP); Tetsuya ASAKURA, Kanagawa (JP); Satoshi KUNIYASU, Kanagawa (JP)

(73) Assignee: FUJIFILM CORPORATION, Tokyo (JP)

(21) Appl. No.: 13/358,800

(22) Filed: Jan. 26, 2012

(30) Foreign Application Priority Data
Jan. 31, 2011 (JP) 2011-019330

(51) Int. Cl. G02B 1/11; B05D 5/06; B05D 3/00; G02B 5/30

(52) U.S. Cl. 359/489.02; 359/601; 427/162

(57) ABSTRACT

An antiglare film is provided and includes: a transparent support; and an antiglare layer formed from a composition comprising a curable resin compound (A) and light-transmitting particles (B). A value obtained by dividing the thickness by an average particle diameter of the light-transmitting particle (B) is from 1.1 to 3.0. The antiglare film has a total haze value of 0.5% to 5.0% and an internal haze value of 1.5% or less. The light-transmitting particles (B) have a specific upper distribution ratio in the antiglare layer of 45% to 99%.

This application is based on and claims priority under 35 U.S.C. §119 from Japanese Patent Application No. 2011-019330, filed Jan. 31, 2011, the entire disclosure of which is herein incorporated by reference.

### BACKGROUND OF THE INVENTION

### 1. Field of the Invention

The present invention relates to an antiglare film, a polarizing plate, an image display and a method for producing the antiglare film.

Various image displays, such as liquid crystal displays (LCDs), plasma display panels (PDPs), electroluminescence displays (ELDs) and cathode ray tube (CRT) displays employ antiglare films and antiglare antireflection films on the surfaces thereof to prevent deterioration of contrast resulting from reflection of external light and glare of images. With the widespread use of such image displays in offices and homes, it is required to improve the antiglare properties of the displays by preventing images of indoor fluorescent lamps and viewers from entering and mirrored on the surfaces of the displays. Also, further improvement of display contrast in bright places is required (see, for example, JP-A-2005-316450).

An antiglare film utilizes an antiglare function which causes scattering of light by the addition of light-transmitting particles to an antiglare layer to form irregularities on the surface of the antiglare layer (surface scattering), and a light-scattering function which occurs by the difference in refractive index between the light-transmitting particles and a light-transmitting resin present in the antiglare layer (internal scattering).

In the case where surface scattering is utilized to impart an antiglare function to an antiglare film, an image display surface may appear to be light brown in color, which deteriorates the vividness of black, and worsens the glare caused by their lens effects due to surface irregularities.

Internal scattering is utilized for the purposes of improving the glare and the viewing angle properties of contrast, etc. However, excessively large internal scattering leads to deterioration in display contrast. Meanwhile, small internal scattering is insufficient to overcome the glare arising from the lens effects of surface irregularities. In both cases, internal scattering faces a dilemma.

JP-A-2010-191412 and JP-A-2010-256850 describe antiglare films for inhibiting glare of images without imparting any more antiglare properties than are necessary to prevent coating films from being whitened, thereby suppressing deterioration of contrast. These documents also describe various factors, such as preferable particle diameters, thicknesses, haze values and shapes of irregularities (Sm values), for the production of the antiglare films. However, in areas where haze is as extremely low as 5% or below, the glare is greatly varied depending on the aggregation and location of particles present in the coating films. For these reasons, it is hard to say that the antiglare films described in JP-A-2010-191412 and JP-A-2010-256850 have the ability to sufficiently inhibit glare. Specifically, JP-A-2010-191412 describes that glare can be overcome at a haze value of 1.0% to 5.0% and an Sm value (average interval between irregularities) of 10 μm to 150 μm. Since the Sm value is calculated by averaging the intervals between irregularities, many surface shapes are possible at the same Sm value. Accordingly, although a haze value of 1.0% to 5.0% and an Sm value of 10 μm to 150 μm are designed, the antiglare film does not necessarily have sufficient ability to inhibit glare. Further, JP-A-2010-256850 defines a ten-point average roughness and a centerline average roughness. For the same reasons as in JP-A-2010-191412, glare is not sufficiently controlled. As is evident from the foregoing, the antiglare designs in the background art have not succeeded in obtaining antiglare films that sufficiently achieve high contrast while at the same time inhibiting glare.

### SUMMARY OF THE INVENTION

An object of the present invention is to provide an antiglare film that has high contrast and inhibits glare. Another object of the present invention is to provide a polarizing plate and an image display that use the antiglare film. Still another object of the present invention is to provide a method for producing the antiglare film.

The above objects can be accomplished by the following matters.

<1> An antiglare film comprising: a transparent support; and an antiglare layer formed from a composition comprising a curable resin compound (A) and light-transmitting particles (B),

wherein

the antiglare layer has a thickness, wherein a value obtained by dividing the thickness by an average particle diameter of the light-transmitting particle (B) is from 1.1 to 3.0,

the antiglare film has a total haze value of 0.5% to 5.0% and an internal haze value of 1.5% or less, and

the light-transmitting particles (B) have an upper distribution ratio in the antiglare layer, calculated by the following equation, of 45% to 99%:

Upper distribution ratio (%)=(the number of the light-transmitting particles (B) present in a 50% region on a side opposite to the transparent support from a center of the antiglare layer in a thickness direction of the antiglare layer)/(the total number of the light-transmitting particles (B) present in the antiglare layer)×100

<2> The antiglare film of item <1>, wherein the upper distribution ratio of the light-transmitting particles (B) is from 70% to 99%.
<3> The antiglare film of item <1> or <2>, wherein the light-transmitting particles (B) have an average particle diameter of 2.0 μm to 6.0 μm.
<4> The antiglare film of any one of items <1> to <3>, wherein the light-transmitting particles (B) has a degree of particle aggregation in the antiglare layer, calculated by the following formula, of 1.0 to 2.0:

Degree of particle aggregation=(the total number of the light-transmitting particles (B) present in the antiglare layer in an in-plane direction)/(the number of domains formed by the light-transmitting particles present in the antiglare layer in the in-plane direction)

<5> The antiglare film of any one of items <1> to <4>, wherein a surface of the antiglare film on a side opposite to the transparent support has a shape having an irregularity waveform measured by a non-contact optical interferometric surface profilomety, wherein an amplitude obtained by analyzing the irregularity waveform by a Fast Fourier transformation is from 0.001 μm to 0.004 μm at a wavelength of 50 μm and 0.001 μm to 0.003 μm at a wavelength of 100 μm.
<6> The antiglare film of any one of items <1> to <5>, wherein the composition for the antiglare layer further comprises a copolymerization product having an amine value of 1 mgKOH/g to 30 mgKOH/g.
<7> The antiglare film of any one of items <1> to <6>, wherein the composition for the antiglare layer further comprises an organic polymer thickener.
<8> The antiglare film of any one of items <1> to <7>, further comprising a low refractive index layer on or above the antiglare layer, the low refractive index layer having a lower refractive index than the antiglare layer.
<9> A polarizing plate comprising: a polarizer; and protective films, wherein at least one of the protective films is an antiglare film of any one of items <1> to <8>.
<10> A polarizing plate comprising: a polarizer; and protective films, wherein one of the protective films is an antiglare film of any one of items <1> to <8> and the other is an optical compensation film having an optical anisotropy.
<11> An image display comprising an antiglare film of any one of items <1> to <8> or a polarizing plate of item <9> or <10> on a display screen thereof.
<12> A method for producing an antiglare film of any one of items <1> to <8>, the method comprising coating, drying, and curing a composition including the curable resin compound (A) and the light-transmitting particles (B) on the transparent support, to form the antiglare layer.
<13> The method of item <12>, wherein the coating and drying of the composition are performed in a state where a normal line of a surface to be coated forms an angle of 0° to 40° relative to a vertically downward direction.
<14> The method of item <12> or <13>, wherein the composition has a viscosity of 1 mPa·s to 30 mPa·s before the coating of the composition.
<15> The method of any one of items <12> to <14>, wherein a solid content of the composition becomes 70% or higher by weight within 20 sec after the coating of the composition.
<16> The method of any one of items <12> to <15>, wherein the composition further comprises two or more solvents, and at least one solvent of the solvents has a boiling point of 80° C. or lower and an amount of the at least one solvent having a boiling point of 80° C. or lower is 30% to 80% by weight based on a total weight of all the solvents.
<17> The method of any one of items <12> to <16>, wherein the composition has a solid content of 30% to 70% by weight.

### DETAILED DESCRIPTION OF THE INVENTION

According to an exemplary embodiment of the present invention, it is possible to provide an antiglare film having high contrast and inhibiting glare. In addition, a polarizing plate and an image display using the antiglare film can be provided.

Exemplary embodiments of the present invention will now be described in detail but the present invention is not limited thereto. The description “from (numerical value 1) to (numerical value 2)” used herein to numerically represent values of physical properties and characteristics refers to “(numerical value 1) or more and (numerical value 2) or less.” The description “(meth)acrylate” refers to “at least either acrylate or methacrylate.” The same also applies for “(meth)acrylic acid” and “(meth)acryloyl.”

### [Antiglare Film]

An antiglare film according to an exemplary embodiment of the invention includes: a transparent support; and an antiglare layer formed from a composition containing a curable resin compound (A) and light-transmitting particles (B). The antiglare layer has a thickness, wherein a value obtained by dividing the thickness by an average particle diameter of the light-transmitting particle (B) is from 1.1 to 3.0, the antiglare film has a total haze value of 0.5% to 5.0% and an internal haze value of 1.5% or less, and the light-transmitting particles (B) have an upper distribution ratio in the antiglare layer, calculated by the following equation, of 45% to 99%.

Upper distribution ratio (%)=(the number of the light-transmitting particles (B) present in a 50% region on a side opposite to the transparent support from a center of the antiglare layer in a thickness direction of the antiglare layer)/(the total number of the light-transmitting particles (B) present in the antiglare layer)×100

Due to this construction, the antiglare film has high contrast and can inhibit glare while being imparted with sufficient antiglare properties.

The antiglare layer in the antiglare film is formed by coating the transparent support with a composition including a curable resin compound (A), light-transmitting particles (B), and optionally, a solvent (hereinafter, the composition is also referred to as “coating composition” or “curable composition”), followed by drying and curing the composition.

The light-transmitting particles present in the composition coated on the transparent support settle toward the transparent support during drying of the coated composition according to the Stokes' equation. In an antiglare film in the background art, the upper distribution ratio of the light-transmitting particles in the dried and cured antiglare layer is generally in the range of 0% to 44%. In this case, the settled isolated particles do not contribute to the formation of irregularities on the surface of the antiglare layer, giving no influence on the antiglare properties of the antiglare film. The antiglare properties of an antiglare film are exhibited when aggregates, each including several to several tens of particles, form irregularities on the surface of an antiglare layer. In some cases, however, irregularities formed by aggregates are large in size and are small in density, resulting in worsening of glare.

In the present invention, the upper distribution ratio of the particles is controlled to be 45% to 99%. This enables the isolated particles to form dense surface irregularities and to inhibit glare. The upper distribution ratio of the particles is more preferably in the range of 50% to 99%, even more preferably 70% to 99%.

The upper distribution ratio of the particles is determined by cutting the cross section of the film in the thickness direction of the antiglare layer and observing the cut face of the film using a microscope, such as an optical microscope, a scanning electron microscope (SEM) or a transmission electron microscope (TEM). From the upper distribution ratio, the thickness of the layer and the location distribution of the particles relative to the thickness can be easily measured. At this time, it is important to count the particles on the cut face and repeat the observation until 100 particles are countered. The upper distribution ratio is determined from the average location of the 100 particles to ensure sufficient precision of measurement.

On the other hand, a particle may be present on the centerline of the thickness (that is, a line corresponding to ½ of the thickness). In this case, when the center of the particle (center of gravity as for a non-spherical particle) lies in the upper portion (opposite the transparent support) relative to the centerline of the thickness, the particle is counted as being distributed in the upper portion. The antiglare layer may form a layer permeating the transparent support. In this case, the permeating layer is excluded from the antiglare layer when the centerline of the thickness is determined. The antiglare layer may be a layer product of two layers or more. In this case, the upper distribution ratio of the particles is obtained in the constituent layer at the outermost surface side (opposite the transparent support) where the layer interface can be identified.

The term “permeating layer” used herein refers to a region formed between the transparent support and the antiglare layer, where the distribution of the compounds (including components of the support and components of the antiglare layer) slowly varies in the direction from the transparent support to the antiglare layer. In this case, the antiglare layer indicates a portion that includes the antiglare layer components only and does not include the transparent support components, and the transparent support indicates a portion that does not include the antiglare layer components. The permeation layer can be defined as a portion where the transparent support components and the antiglare layer components are detected simultaneously when the film is cut using a microtome and the cross section thereof is analyzed using a time-of-flight secondary ion mass spectrometer (TOF-SIMS). Similarly, the thickness of this region can be measured using cross-sectional information from TOF-SIMS.

As described above, the antiglare layer is formed by coating the transparent support with a composition including at least a curable resin compound (A), light-transmitting particles (B), a solvent and the like, followed by drying and curing. The light-transmitting particles of the coated composition settle toward the transparent support during drying after coating. The settling of the particles follows the Stokes' equation (Equation 1):

$${v}_{s} = \frac{{D}_{p}^{2} ( {ρ}_{p} - {ρ}_{f} ) g}{18 η} \qquad Equation 1$$

In Equation 1, Dₚ is a particle diameter [m], νₛ is a terminal velocity of particles [m/s], ρₚ is a density of the particles [kg/m³], η is a viscosity of fluid [Pa·s], ρ_{f} is a density of fluid [kg/m³], and g is a acceleration of gravity (constant).

In the present invention, the following methods are preferably used to inhibit the particles from settling and set the upper distribution ratio of the particles to 45% to 99%.

### (1) The Particle Diameter of the Light-Transmitting Particles is Reduced.

Specifically, the average particle diameter of the light-transmitting particles is preferably from 2 μm to 6 μm, more preferably from 3 μm to 6 μm. The term “average particle diameter” used herein represents a primary particle diameter. When the average particle diameter of the light-transmitting particles is not smaller than 2 μm, a suitable thickness of the antiglare layer having an irregular surface shape can be obtained, leading to improvement of film hardness. Meanwhile, when the particle diameter is not larger than 6 μm, the particles settle at a low velocity to form dense surface irregularities so that glare can be inhibited.

### (2) The Degree of Particle Aggregation is Lowered to Reduce the Effective Particle Diameter of the Particles.

The degree of particle aggregation in the antiglare layer is preferably from 1.0 to 2.0, more preferably from 1.0 to 1.3. Within this range, the effective particle diameter of the particles in the antiglare layer can be reduced. The term “effective particle diameter” refers to a particle diameter of the particles in the layer (That is, when particles aggregate in the layer, the effective particle diameter is the particle diameter of the aggregate). This reduction in effective particle diameter can lead to a low settling velocity of the particles. A polymer dispersant, which will be explained later, may be added to the coating composition in order to reduce the degree of particle aggregation. The degree of particle aggregation is calculated by the following formula.

Degree of particle aggregation=(the total number of particles present in the antiglare layer in an in-plane direction)/(the number of domains formed by particles present in the antiglare layer in the in-plane direction)

The term “domains formed by particles” is intended to include individual particles that do not aggregate as well as the aggregates formed by particles. The number of the domains is given by counting each of particles that do not aggregate as one domain and an aggregate of particles that form the aggregate as one domain.

The degree of particle aggregation can be estimated from a transmission optical micrograph of the film by the above formula. For higher precision of measurement, it is preferred to estimate the degree of particle aggregation by measuring the degrees of particle aggregation in areas of 1 mm² or larger, and averaging the measured values.

### (3) The Viscosity of the Coating Composition is Raised.

The viscosity of the coating composition is preferably in the range of 1 mPa·s to 30 mPa·s, more preferably 5 mPa·s to 15 mPa·s. Within this range, the shape of the coated surface is maintained good enough to keep the particles from settling. The viscosity of the coating composition can be adjusted depending on the solid content thereof and the amount of a polymer thickener added.

### (4) The Solvent is Rapidly Dried to Increase the Viscosity of the Coating Composition During Drying.

The solid content of the coating composition is preferably adjusted to 70% by weight (% by mass) or more, more preferably 80% by weight, within 20 sec after the coating of the composition. The viscosity of the coating composition is preferably adjusted to 40 mPa·s or more, more preferably 100 mPa·s or more, within 20 sec after the coating of the composition. A further increase in the viscosity of the coating composition during the drying of the composition is preferably achieved by the selection of a solvent having an appropriate boiling point, which will be explained later.

The solid content of the coating composition before the coating of the coating composition is preferably from 30% to 70% by weight, more preferably from 50% to 65% by weight. Within this range, coatability of the coating composition is maintained good enough to keep the particles from settling.

According to the methods (1) to (4), the upper distribution ratio of the particles can be increased to from 45% to about 50%. Further, the following methods (5) or (6) can also be used to increase the upper distribution ratio to 45% to 99%. It is preferred to combine the methods (1) to (6). Combinations of the methods (1) to (4) with the methods (5) or (6) are particularly preferred because they can increase the upper distribution ratio of the particles whose degree of aggregation has been inhibited.

(5) The Coating Composition is Coated or Dried in a State in which a Surface to be Coated is Directed Downwardly to Distribute the Light-Transmitting Particles at the Film Surface Side (Opposite the Transparent Support).

Coating and drying of the coating composition in a state in which a surface to be coated is directed downwardly enable the particles to be distributed at the film surface side by gravity.

The expression “state in which a surface to be coated is directed downwardly” means a state in which the normal line of a surface to be coated forms an angle of 0° to smaller than 90° relative to the vertically downward direction. The angle is preferably from 0° to 40°.

### (6) Two or More Layers are Formed Simultaneously by Coating.

It is preferred to make the amount of the light-transmitting particles in the upper layer (opposite the transparent support) larger than that of the light-transmitting particles in the lower layer (toward the transparent support).

The value obtained by dividing the thickness of the antiglare layer by the average particle diameter of the light-transmitting particles is adjusted to from 1.1 to 3.0. This value is preferably from 1.3 to 2.5, more preferably 1.6 to 2.2. When the value is 1.1 or greater, the number of defects inherent to the particles can be reduced, and as a result, a good surface shape can be obtained. Meanwhile, when the value is 3.0 or less, curling can be suppressed, and as a result, good antiglare properties can be obtained.

The thickness of the antiglare layer is preferably from 3 μm to 36 μm, more preferably from 4 μm to 15 μm, even more preferably from 5 μm to 13 μm. The thickness of the antiglare layer can be determined, for example, by averaging the thicknesses of the antiglare layer in the direction normal to the transparent support on a cross-sectional scanning electron micrograph of the antiglare layer.

The antiglare film has a total haze value of 0.5% to 5.0% and an internal haze value of 1.5% or less.

When the total haze value is 0.5% or greater, proper antiglare properties can be imparted. Meanwhile, when the total haze value is 5.0% or less, a feeling of bright brown can be reduced. The total haze value is preferably from 1.0% to 3.0%.

Good contrast can be obtained at an internal haze value of 1.5% or less. The internal haze value is preferably 1.0% or less, more preferably 0.5% or less, even more preferably 0.3% or less.

The total haze and internal haze values of the antiglare film can be measured by following procedures.

[1] In accordance with JIS-K7136, the total haze value (H) of the antiglare film can be measured using a haze meter (NDH2000, Nippon Denshoku Industries Co., Ltd.).
[2] Several drops of an immersion oil for microscopes (Immersion Oil Type A, Nikon, refractive index n=1.515) are dropped on both surfaces of the antiglare film. The antiglare film is interposed between two 1 mm thick glass plates (Micro-slide glass, product No. S9111, MATSUNAMI) and is completely in tight contact with the glass plates. The haze of the resulting structure is measured in a state in which the surface haze is removed. Separately, the haze of a structure in which the silicone oil only is filled between the two glass plates is measured. The internal haze (Hin) of the film is calculated by subtracting the haze of the latter structure from the haze of the former structure.

The surface haze (Hout) of the film is calculated by subtracting the internal haze (Hin) calculated in [2] from the total haze (H) measured in [1].

A surface of the antiglare film (a surface of the antiglare film on a side opposite to the transparent support) has a shape having an irregularity waveform measured by a non-contact optical interferometric surface profilomety, and an amplitude obtained by analyzing the irregularity waveform by a Fast Fourier transformation is from 0.001 μm to 0.004 μm at a wavelength of 50 μm and 0.001 μm to 0.003 μm at a wavelength of 100 μm. It is more preferred that the amplitude is from 0.0015 μm to 0.003 μm at a wavelength of 50 μm and is from 0.001 μm to 0.002 μm at a wavelength of 100 μm. Good antiglare properties can be obtained when the amplitude is from 0.001 μm to 0.004 μm at a wavelength of 50 μm. Glare can be inhibited when the amplitude is from 0.001 to 0.003 μm at a wavelength of 100 μm.

The amplitude at a wavelength of 100 μm measured by non-contactoptical interferometric surface profilometry is not particularly limited. For example, the amplitude can be measured using Micromap, Vertscan 2.0 or Vertscan 3.0 (Ryoka systems Inc.) and can be analyzed by Fast Fourier transformation.

The reason why the amplitude of 0.003 μm or less at a wavelength of 100 μm is effective in inhibiting glare is thought to be because irregularities having a size of about 100 μm interfere with R, G and B pixels, each of which has a size of approximately tens of μm, of a liquid panel to worsen glare. For this reason, it is found that inhibition of glare is compatible with antiglare properties when the height of irregularities having a size (wavelength 100 μm) causing glare is lowered to a smaller size (wavelength 50 μm) to impart antiglare properties. Ra (surface roughness) and Sm (average interval between irregularities) are generally indicative of the shape of surface irregularities. Since Ra and Sm are average values of shapes of irregularities, they are thought to be insufficiently indicative of glare. In the present invention, the surface shape is designed using the parameters to make inhibition of glare compatible with antiglare properties.

Hereinafter, an explanation will be given regarding individual components of the composition for the formation of the antiglare layer.

### (A) Curable Resin Compound

In the present invention, the curable composition for the formation of the antiglare layer contains at least one curable resin compound. The curable resin compound is preferably a component that is formed into a light-transmitting resin after curing to function as a resin binder forming a matrix constituting the antiglare layer.

Such a resin binder is preferably a light-transmitting polymer (also called a ‘binder polymer’) having a saturated hydrocarbon chain as the main chain after curing by irradiation with ionizing radiation, etc. The binder polymer preferably has a crosslinked structure after curing.

The binder polymer having a saturated hydrocarbon chain as the main chain after curing is preferably a polymer of an ethylenically unsaturated monomer described below.

The binder polymer having a saturated hydrocarbon chain as the main chain and a crosslinked structure is preferably a (co)polymer of a monomer having two or more ethylenically unsaturated groups. In order to render the antiglare layer highly refractive, it is preferred that the monomer includes an aromatic ring and/or at least one atom selected from halogen atoms other than fluorine, sulfur atoms, phosphorus atoms and nitrogen atoms in the structure thereof.

The curable resin compound used in the composition for the formation of the antiglare layer is preferably a monomer having two or more ethylenically unsaturated groups. Examples of such monomers include esters of polyhydric alcohols and (meth)acrylic acid {e.g., ethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexanetetramethacrylate, polyurethane polyacrylate and polyester polyacrylate}, vinylbenzene and derivatives thereof (e.g., 1,4-divinylbenzene, 2-acryloylethyl 4-vinylbenzoate, 1,4-divinylcyclohexanone), vinyl sulfones (for example, divinyl sulfone), and (meth)acrylamides (for example, methylene bisacrylamide). Commercially available polyfunctional acrylate compounds having (meth)acryloyl groups, for example, KAYARAD DPHA and PET-30 (Nippon Kayaku Co., Ltd.) and NKester A-TMMT and A-TMPT (Shin-Nakamura Chemical Co., Ltd.) may also be used. From the viewpoint of reducing curing shrinkage to inhibit curling, the addition of an ethylene oxide-, propylene oxide- or caprolactone-added acrylate is preferred to increase the intervals between crosslinked points. Examples of preferred ethylene oxide-, propylene oxide- and caprolactone-added acrylates include ethylene oxide-added trimethylolpropane triacrylate (for example, Biscoat V#360, Osaka Organic Chemical Industry Ltd.), glycerin propylene oxide-added triacrylates (for example, V#GPT, Osaka Organic Chemical Industry Ltd.), and caprolactone-added dipentaerythritol hexaacrylate (for example, DPCA-20, 120, Nippon Kayaku Co., Ltd.). A combination of two or more different kinds of monomers having two or more ethylenically unsaturated groups is also preferred.

Other examples of suitable curable resin compounds include oligomers and prepolymers of polyfunctional compounds, such as resins having two or more ethylenically unsaturated groups and a relatively low molecular weight, e.g., polyester resins, polyether resins, acrylic resins, epoxy resins, urethane resins, alkyd resins, spiroacetal resins, polybutadiene resins and polythiolpolyene resins, and polyhydric alcohols. These oligomers or prepolymers may be used in combination of two or more kinds thereof.

The resin having two or more ethylenically unsaturated groups is preferably present in an amount of 10% to 100% by weight, based on the total weight of the curable resin compound.

The monomer having ethylenically unsaturated groups may be polymerized by irradiation with ionizing radiation or heating in the presence of a photo-radical polymerization initiator or a thermal radical polymerization initiator. Accordingly, the antiglare layer is formed by preparing a coating solution containing the monomer having ethylenically unsaturated groups, a photo-radical polymerization initiator or thermal radical polymerization initiator, resin particles, a dispersion solvent, and optionally an inorganic filler, a coating aid, other additives, etc., coating the coating solution on a transparent substrate, and polymerizing the monomer by irradiation with ionizing radiation or heating to cure the coating solution. It is also preferred to perform the curing by a combination of irradiation with ionizing radiation and heating. Commercially available compounds can be used as the photopolymerization initiator and the thermal polymerization initiator. Two or more kinds of photopolymerization initiators, which will be described below, may be used in the present invention. In this case, it is preferred that at least one kind of the photopolymerization initiators is a phosphine oxide initiator and at least one kind thereof is other than a phosphine oxide initiator.

One or more curable resin compounds may be used in the present invention. In this case, the curable resin compounds are preferably present in an amount of 60% to 99% by weight, more preferably 70% to 97% by weight, even more preferably 80% to 95% by weight, based on the total solid content of the curable composition for the formation of the antiglare layer. Within this range, high film strength of the antiglare layer can be obtained.

The refractive index of the antiglare layer without light-transmitting particles is preferably from 1.46 to 1.65, more preferably from 1.49 to 1.60, particularly preferably from 1.49 to 1.53. Within this range, no visible coating unevenness and interference unevenness are left and high hardness of the antiglare layer can be obtained.

The refractive index of the film of the antiglare layer without light-transmitting particles may be directly measured using an Abbe refractometer or may be quantitatively evaluated by reflection spectroscopy or spectral ellipsometry.

### (B) Light-Transmitting Particles

In the present invention, the curable composition for the formation of the antiglare layer contains at least one kind of light-transmitting particles. The average particle diameter of the light-transmitting particles is preferably from 2 μm to 6 μm, more preferably from 3 μm to 6 μm.

The light-transmitting particles may be either organic particles (resin particles) or inorganic particles or combinations thereof. Organic particles are preferred for ease of refractive index control and formation of minute irregularities.

For adjustment of the surface shape of the antiglare layer to the specific range defined in the present invention, it is also preferred to use two kinds of particles having different average particle diameters or two kinds of particles having difference refractive indices.

The particle diameter of the light-transmitting particles can be measured by any suitable method for the measurement of particles. For example, the particle diameter of the light-transmitting particles may be measured by measuring the particle size distribution of the particles by the Coulter-counter method, converting the particle size distribution to a particle number distribution, and computing the particle size from the particle number distribution. Alternatively, the particle diameter of the light-transmitting particles may be measured by averaging the particle diameters of 100 particles on a transmission electron micrograph taken at a magnification of 500,000 to 2,000,000.

In the present invention, the average particle diameter of the light-transmitting particles is obtained by the Coulter-counter method.

The inorganic particles may be, for example, aggregated metal oxide particles. A mixture of one or more kinds of inorganic particles may be used. Aggregated silica particles and aggregated alumina particles are particularly suitable as the aggregated metal oxide particles. Of these, aggregates of silica particles having a primary particle diameter of several tens of nm are preferred in that suitable surface irregularities can be stably formed. There is no restriction on the method for the production of aggregated silica. For example, aggregated silica may be synthesized from sodium silicate and sulfuric acid by their neutralization, the so-called wet process. Such wet processes are broadly classified into precipitation and gelling processes. Any process may be used in the present invention.

The light-transmitting particles may be resin particles (hereinafter referred to as “light-transmitting resin particles”). The refractive index of the light-transmitting resin particles is measured by dispersing equivalent amounts of the light-transmitting resin particles in mixed solvents of two solvents, whose mixing ratio is varied to change the refractive index, having different refractive indices selected from methylene iodide, 1,2-dibromopropane and n-hexane, measuring the turbidity values of the dispersions, and measuring the refractive index of the dispersion having a minimum turbidity using an Abbe refractometer.

Internal scattering can be imparted to the antiglare layer by controlling the difference in refractive index between the light-transmitting resin particles and the binder. However, an excessively large difference in refractive index involves deterioration of contrast. Thus, it is preferred to design such that the difference in refractive index between the light-transmitting resin particles and the antiglare layer without the light-transmitting resin particles is 0.050 or below, more preferably 0.020 or less, most preferably 0.010 or less. This design ensures high contrast of the antiglare film On the other hand, when two or more kinds of light-transmitting resin particles are used in the present invention, their refractive indices may be the same as or different from each other.

Specific examples of the light-transmitting resin particles include crosslinked polymethyl methacrylate particles, crosslinked methyl methacrylate-styrene copolymer particles, crosslinked polystyrene particles, crosslinked methyl methacrylate-methyl acrylate copolymer particles, crosslinked acrylate-styrene copolymer particles, melamine•formaldehyde resin particles, and benzoguanamine-formaldehyde resin particles. Of these, preferred are crosslinked styrene particles, crosslinked polymethyl methacrylate particles, and crosslinked methyl methacrylate-styrene copolymer particles. These resin particles may be surface modified with compounds containing at least one fluorine atom, silicon atom, carboxyl group, hydroxyl group, amino group, sulfonate group or phosphate group by chemical bonding. The surface-modified resin particles may also be used as the light-transmitting resin particles in the present invention. Nanosized inorganic fine particles, e.g., silica and zirconia particles, may be bound to the surfaces of the resin particles. The surface-bound resin particles may also be used as the light-transmitting resin particles in the present invention.

One or more kinds of light-transmitting particles may be used in the present invention. The content of the light-transmitting particles is preferably from 3% to 20% by weight, more preferably from 5% to 18% by weight, even more preferably from 7% to 15% by weight, based on the total solid content of the antiglare layer. Within this range, the antiglare film can be imparted with antiglare properties and can offer a high denseness of black.

It is preferred to adjust the degree of particle aggregation in the antiglare layer to 1.0 to 2.0, as described above.

[Copolymerization Product Having an Amine Value of 1 to 30 mgKOH/g]

For the purpose of adjusting the degree of particle aggregation in the antiglare layer to 1.0 to 2.0, it is preferred that the antiglare layer contains a copolymerization product having an amine value of 1 to 30 mgKOH/g. The copolymerization product may be present in the curable composition for the formation of the antiglare layer.

The amount of the copolymerization product added to the antiglare layer or the curable composition is preferably from 0.01% to 5.0% by weight, more preferably from 0.1% to 3.0% by weight, based on the weight of the light-transmitting particles. The amine groups act as adsorptive groups to adsorb the copolymerization product to the surface of the light-transmitting particles, resulting in a steric hindrance between the light-transmitting particles. The steric hindrance is assumed to increase the dispersibility of the particles, facilitating the formation of dense irregularities.

The copolymerization product having an amine value of 1 to 30 mgKOH/g is not particularly limited to specific compounds so long as it satisfies the foregoing physical properties. Commercially available wetting dispersants are preferably used, and examples thereof include: wetting dispersants from BYK-Chemie, such as Disperbyk-161 (11), Disperbyk-162 (13), Disperbyk-163 (10), Disperbyk-164 (18), Disperbyk-166 (20), Disperbyk-167 (13), Disperbyk-168 (11), Disperbyk-182 (13), Disperbyk-183 (17), Disperbyk-184 (15), Disperbyk-185 (17), Disperbyk-2000 (4), Disperbyk-2001 (29), Disperbyk-2009 (4), Disperbyk-2050 (30) and Disperbyk-2070 (20); and pigment dispersants from Kusumoto Chemicals, Ltd., such as Disparlon DA-703-50, Disparlon DA-325, Disparlon DA-7301, Disparlon 1860 and Disparlon 7004, wherein the values in parentheses represent an amine value. Of these, modified acrylic block copolymerization products are preferred due to their abilities to disperse the particles and to prevent side effects on film transparency. Disperbyk-2000 and Disperbyk-166 are particularly effectively used. The above copolymerization products may be used alone or in combination of two or more thereof.

There is no particular restriction on the method for dispersing the light-transmitting particles. The light-transmitting particles may be dispersed using a suitable dispersion instrument known in the art. Examples of such dispersion instruments include ball mills, roll mills, bead mills, high-speed dispersers, Polytron homogenizers, dissolvers, magnetic stirrers and sonicators, The use of Polytron homogenizers, dissolvers, magnetic stirrers and sonicators is particularly preferred. It is preferred that the light-transmitting particles are dispersed in an organic solvent using a dispersion instrument, the copolymerization product having an amine value of 1 to 30 mgKOH/g is added thereto, and the mixture is dispersed.

### [Organic Polymer Thickener]

The curable composition for the formation of the antiglare layer in the present invention may include an organic polymer thickener.

The term “thickener” used herein means an agent that is added to increase the viscosity of a solution. Upon the addition of the thickener, the viscosity of the coating solution is preferably increased by 1 mPa·s to 50 mPa·s, more preferably by 5 mPa·s to 15 mPa·s.

In the present invention, the organic polymer thickener is preferably a cellulose ester. Cellulose acetate butyrate is particularly preferred. Examples of organic polymer thickeners suitable for use in the present invention include the following polymers:
Poly-ε-caprolactone
Poly-ε-caprolactone diol
Poly-ε-caprolactone triol
Polyvinyl acetate
Poly(ethylene adipate)
Poly(1,4-butylene adipate)
Poly(1,4-butylene glutarate)
Poly(1,4-butylene succinate)
Poly(1,4-butylene terephthalate)
Poly(ethylene terephthalate)
Poly(2-methyl-1,3-propylene adipate)
Poly(2-methyl-1,3-propylene glutarate)
Poly(neopentyl glycol adipate)
Poly(neopentyl glycol sebacate)
Poly(1,3-propylene adipate)
Poly(1,3-propylene glutarate)
Polyvinyl butyral
Polyvinyl formal
Polyvinyl acetal
Polyvinyl propanal
Polyvinyl hexanal
Polyvinylpyrrolidone
Polyacrylic ester
Polymethacrylic ester
Cellulose acetate
Cellulose propionate
Cellulose acetate butyrate

The number average molecular weight of the organic polymer thickener is preferably from 3,000 to 400,000, more preferably 4,000 to 300,000, particularly preferably 5,000 to 200,000.

The amount of the organic polymer thickener added is preferably from 0.5% to 10% by weight, more preferably from 1.0% to 7.0% by weight, particularly preferably from 2.0% to 5.0% by weight, based on the total solid content of the curable composition for the formation of the antiglare layer.

### [Photopolymerization Initiator]

The monomer having ethylenically unsaturated groups may be polymerized by irradiation with ionizing radiation or heating in the presence of a photo-radical polymerization initiator or a thermal radical polymerization initiator. Accordingly, the antiglare layer is formed by preparing a coating solution containing a monomer having ethylenically unsaturated groups, a photo-radical polymerization initiator or a thermal radical polymerization initiator, the particles and optionally an inorganic filler, a coating aid, other additives, an organic solvent, etc., coating the coating solution on a transparent support, and polymerizing the monomer by irradiation with ionizing radiation or heating to cure the coating solution. It is also preferred to perform the curing by a combination of irradiation with ionizing radiation and heating. Commercially available compounds can be used as the photopolymerization initiator and the thermal polymerization initiator, and examples thereof are described in “The Latest UV Curing Techniques,” p. 159, published by Takasusuki Kazuhiro, Technical Information Institute Co., Ltd., 1991 and the catalog of Ciba Specialty Chemicals Inc. The photopolymerization initiator may be used in combination with one or more other photopolymerization initiators.

The photopolymerization initiator is preferably used in an amount ranging from 0.1 to 15 parts by weight (parts by mass), more preferably from 1 to 10 parts by weight, most preferably from 1 to 6 parts by weight, based on 100 parts by weight of the curable resin compound of the curable composition for the formation of the antiglare layer.

When two or more kinds of photopolymerization initiators are used in the present invention, it is preferred that at least one kind of the photopolymerization initiators is a phosphine oxide initiator and at least one kind thereof is other than a phosphine oxide initiator.

### (Phosphine Oxide Photopolymerization Initiator)

The phosphine oxide photopolymerization initiator used in the present invention is preferably one that induces an n-π* transition when absorbing light and has photobleaching effect. Specific examples of preferred phosphine oxide photopolymerization initiators include 2,4,6-trimethylbenzoyldiphenylphosphine oxide and bis(2,4,6-trimethylbenzoyl)-phenylphosphine oxide.

IRGACURE 819 and DAROCUR TPO (BASF) are preferred commercially available products of phosphine oxide photopolymerization initiators.

One or more kinds of phosphine oxide photopolymerization initiators may be used in the present invention.

(Photopolymerization Initiators Other than Phosphine Oxide Photopolymerization Initiators)

Photopolymerization initiators other than phosphine oxide photopolymerization initiators may be used in the present invention. Surface curable photopolymerization initiators are preferred as the photopolymerization initiators other than phosphine oxide photopolymerization initiators. Specific examples of photopolymerization initiators other than phosphine oxide photopolymerization initiators include acetophenones, benzoins, benzophenones, ketals, anthraquinones, thioxanthones, azo compounds, peroxides (see JP-A-2001-139663, etc.), 2,3-dialkyldione compounds, disulfide compounds, fluoroamine compounds, aromatic sulfoniums, lophine dimers, onium salts, borate salts, active esters, active halogens, inorganic complexes and coumarins.

Examples of the acetophenones include 2,2-dimethoxyacetophenone, 2,2-diethoxyacetophenone, p-dimethylacetophenone, 1-hydroxy-dimethyl phenyl ketone, 1-hydroxy-dimethyl-p-isopropyl phenyl ketone, 1-hydroxycyclohexyl phenyl ketone, 2-methyl-4-methylthio-2-morpholinopropiophenone, 2-benzyl-2-dimethylamino-1-(4-morphilinophenyl)butanone, 4-phenoxydichloroacetophenone and 4-t-butyldichloroacetophenone.

Examples of the benzoins include benzoin, benzoin methyl ether, benzoin ethyl ether, benzoin isopropyl ether, benzyl dimethyl ketal, benzoin benzenesulfonic ester, benzoin toluenesulfonic ester, benzoin methyl ether, benzoin ethyl ether and benzoin isopropyl ether. Examples of the benzophenones include benzophenone, hydroxybenzophenone, 4-benzoyl-4′-methyldiphenyl sulfide, 2,4-dichlorobenzophenone, 4,4-dichlorobenzophenone, p-chlorobenzophenone, 4,4′-dimethylaminobenzophenone (Michler's ketone) and 3,3′,4,4′-tetra(t-butylperoxycarbonyl)benzophenone.

As the borate salts, there may be exemplified organic boric acid salts described in Japanese Patent No. 2764769, JP-A-2002-116539 and Kunz and Martin, “Rad Tech' 98. Proceeding, April, pages 19-22, 1998, Chicago.” Examples of the organic boric acid salts are described in Paragraphs [0022] to [0027] of JP-A-2002-116539.

Specific examples of other organoboron compounds include organoboron transition metal coordination complexes described in JP-A-6-348011, JP-A-7-128785, JP-A-7-140589, JP-A-7-306527 and JP-A-7-292014, and ionic complexes with cationic dyes.

Examples of the active esters include 1,2-octanedione, 1-[4-(phenylthio)phenyl]-1,2-(O-benzoyloxime), sulfonic esters and cyclic active ester compounds.

Specifically, compound Nos. 1 to 21 described in Examples Section of JP-A-2000-80068 are particularly preferred as the active esters.

Examples of the onium salts include aromatic diazonium salts, aromatic iodonium salts and aromatic sulfonium salts.

As the active halogens, there may be specifically exemplified compounds described in Wakabayashi, et al., “Bull Chem. Soc. Japan,” Vol. 42, page 2924 (1969), U.S. Pat. No. 3,905,815, JP-A-5-27830 and M. P. Hutt, “Journal of Heterocyclic Chemistry,” Vol. 1 (No. 3), 1970. Particularly, the active halogens are oxazole compounds and s-triazine compounds which are substituted with a trihalomethyl group.

Examples of more suitable active halogens include s-triazine derivatives in which at least one mono-, di- or trihalogenated methyl group is bonded to the s-triazine ring.

Examples of preferred commercially available photo-radical polymerization initiators include: KAYACURE DETX-S, BP-100, BDMK, CTX, BMS, 2-EAQ, ABQ, CPTX, EPD, ITX, QTX, BTC, MCA, etc., all of which are available from Nippon Kayaku Co., Ltd.; Irgacure 651, 184, 500, 907, 369, 1173, 1870, 2959, 4265, 4263, 127, etc. and DAROCUR 1173, all of which are available from BASF; Esacure KIP100F, KB1, EB3, BP, X33, KT046, KT37, KIP150, TZT, etc., all of which are available from Sartmer Company Inc.; and combinations thereof.

One or more kinds of photopolymerization initiators other than phosphine oxide photopolymerization initiators may be used in the present invention.

The phosphine oxide initiator is preferably used in an amount of 20% to 95% by weight, more preferably 30% to 90% by weight, most preferably 40% to 85% by weight, based on the total amount of the photopolymerization initiators. Within this range, a rough feeling of surface and high film hardness can be compatible.

### [Surfactant]

Preferably, the curable composition for the formation of the antiglare layer of the present invention contains either a fluorine-based surfactant or a silicone-based surfactant or both of them. The use of the surfactant is advantageous in suppressing coating interference unevenness, drying interference unevenness and spot defects, ensuring uniformity of surface shape. A fluorine-based surfactant is particularly preferred because even a small amount thereof effectively suppresses surface shape faults, such as coating unevenness, drying unevenness and spot defects. The surfactant allows the curable composition to have high-speed coatability while increasing the uniformity of surface shape, leading to high productivity.

The fluorine-based surfactant is preferably a fluoro-aliphatic group-containing copolymer (hereinafter, also abbreviated as “fluorinated polymer”). Examples of suitable fluorinated polymers include acrylic resins, methacrylic resins and copolymers thereof with vinyl monomers copolymerizable with them, each of which includes a repeating unit corresponding to the following monomer (i), or a repeating unit corresponding to the following monomer (i) and a repeating unit corresponding to the following monomer (ii).

(i) Fluoro-Aliphatic Group-Containing Monomer Represented by Formula (A):

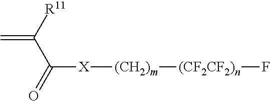

In Formula (A), R¹¹ represents a hydrogen atom or a methyl group, X represents an oxygen atom, a sulfur atom or —N(R¹²)—, m represents an integer from 1 to 6, and n represents an integer from 2 to 4. R¹² represents a hydrogen atom or a C₁-C₄ alkyl group, specifically methyl, ethyl, propyl or methyl. R¹² is preferably a hydrogen atom or a methyl group. X is preferably an oxygen atom.

(ii) Monomer copolymerizable with the monomer (i), represented by Formula (B):

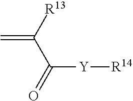

In Formula (B), R¹³ represents a hydrogen atom or a methyl group, Y represents an oxygen atom, a sulfur atom or —N(R¹⁵)—. R¹⁵ represents a hydrogen atom or a C₁-C₄ alkyl group, specifically methyl, ethyl, propyl or butyl. R¹⁵ is preferably a hydrogen atom or a methyl group. Y is preferably an oxygen atom, —N(H)— or —N(CH₃)—.

R¹⁴ represents a substituted or unsubstituted C₄-C₂₀ straight, branched or cyclic alkyl group. Examples of suitable substituents of the alkyl group R¹⁴ include, but are not limited to, hydroxyl groups, alkylcarbonyl groups, arylcarbonyl groups, carboxyl groups, alkyl ether groups, aryl ether groups, halogen atoms, such as fluorine, chlorine and bromine atoms, nitro groups, cyano groups and amino groups. Examples of suitable C₄-C₂₀ straight, branched and cyclic alkyl groups include: straight and branched alkyl groups, such as butyl, pentyl, hexyl, heptyl, octyl, nonyl, decyl, undecyl, dodecyl, tridecyl, tetradecyl, pentadecyl, octadecyl and eicosanyl groups; monocyclic cycloalkyl groups, such as cyclohexyl and cycloheptyl groups; and polycyclic cycloalkyl groups, such as bicycloheptyl, bicyclodecyl, tricycloundecyl, tetracyclododecyl, adamantyl, norbornyl and tetracyclodecyl groups.

The amount of the fluoro-aliphatic group-containing monomer represented by Formula (A) included in the fluorinated polymer used in the present invention is preferably from 10 mol % or more, preferably from 15 to 70 mol %, more preferably from 20 to 60 mol %, based on the total number of moles of the constituent monomers of the fluorinated polymer.

The weight average molecular weight of the fluorinated polymer used in the present invention is preferably from 3,000 to 100,000, more preferably from 5,000 to 80,000. The amount of the fluorinated polymer added is preferably from 0.001 to 5 parts by weight, more preferably from 0.005 to 3 parts by weight, even more preferably from 0.01 to 1 part by weight, based on 100 parts by weight of the coating solution. When the fluorinated polymer is added in an amount of 0.001 parts by weight or more, sufficient effects of adding the fluorinated polymer can be obtained. Meanwhile, when the fluorinated polymer is added in an amount of 5 parts by weight or less, drying of the coating film is sufficiently effected and the performance characteristics (for example, reflectance and scratch resistance) of the coating film are not adversely affected.

### [Solvent]

The coating composition for the formation of each layer of the antiglare film according to the present invention uses various solvents selected from various viewpoints such as solvents capable of dissolving or dispersing the other components, solvents that can easily form an even surface during coating and drying, solvents that can ensure solution storability, and solvents having an appropriate saturated vapor pressure.

A mixture of two or more kinds of solvents may be used. In this case, particularly preferred is a mixture containing a relatively large amount of a solvent having a boiling point of 100° C. or lower at ambient pressure and room temperature in view of drying load and a relatively small amount of a solvent having a boiling point higher than 100° C. in view of drying speed adjustment.

The coating composition for the formation of the antiglare layer according to the present invention may contain a solvent having a boiling point of 80° C. or lower. In this case, the solvent having a boiling point of 80° C. or lower is preferably used in an amount of 30% to 80% by weight, more preferably 50% to 70% by weight, based on the weight of all the solvents of the coating composition. Within this range, the resin component can be properly inhibited from permeating the transparent support and the coating composition becomes rapidly viscous during drying, thereby inhibiting the particles from settling.

Examples of solvents having a boiling point of 100° C. or lower include: hydrocarbons, such as hexane (68.7° C.), heptane (98.4° C.), cyclohexane (80.7° C.) and benzene (80.1° C.); halogenated hydrocarbons, such as dichloromethane (39.8° C.), chloroform (61.2° C.), carbon tetrachloride (76.8° C.), 1,2-dichl oro ethane (83.5° C.) and trichloroethylene (87.2° C.); ethers, such as diethyl ether (34.6° C.), diisopropyl ether (68.5° C.), dipropyl ether (90.5° C.) and tetrahydrofuran (66° C.); esters, such as ethyl formate (54.2° C.), methyl acetate (57.8° C.), ethyl acetate (77.1° C.) and isopropyl acetate (89° C.); ketones, such as acetone (56.1° C.) and 2-butanone (also known as methyl ethyl ketone, 79.6° C.); alcohols, such as methanol (64.5° C.), ethanol (78.3° C.), 2-propanol (82.4° C.) and 1-propanol (97.2° C.); cyano compounds, such as acetonitrile (81.6° C.) and propionitrile (97.4° C.); and carbon disulfide (46.2° C.). Of these, ketones and esters are preferred. Ketones, such as 2-butanone, are particularly preferred.

Examples of solvents having a boiling point higher than 100° C. include octane (125.7° C.), toluene (110.6° C.), xylene (138° C.), tetrachloroethylene (121.2° C.), chlorobenzene (131.7° C.), dioxane (101.3° C.), dibutyl ether (142.4° C.), isobutyl acetate (118° C.), cyclohexanone (155.7° C.), 2-methyl-4-pentanone (also known as MIBK, 115.9° C.), 1-butanol (117.7° C.), N,N-dimethylformamide (153° C.), N,N-dimethylacetamide (166° C.), and dimethyl sulfoxide (189° C.). Cyclohexanone and 2-methyl-4-pentanone are preferred.

### [Inorganic Filler]

The antiglare layer of the present invention may also use an inorganic filler in addition to the light-transmitting particles for the purposes of refractive index adjustment, film strength adjustment, curing shrinkage reduction, and reflectance reduction in the case of forming a low refractive index layer. It is also preferred that the antiglare layer of the present invention contains a high refractive index fine inorganic filler including an oxide containing at least one metal element selected from titanium, zirconium, aluminum, indium, zinc, tin and antimony and having an average primary particle diameter of typically 0.2 μm or less, preferably 0.1 μm or less, more preferably from 0.06 μm to 1 μm.

It is necessary to lower the refractive index of the matrix in order to adjust the difference in refractive index between the matrix and the light-transmitting particles. In this case, low refractive index fine inorganic fillers, such as silica fine particles or hollow silica fine particles, may be used. The preferred particle sizes of the low refractive index fine inorganic fillers are the same as the particle size of the high refractive index fine inorganic filler.

It is also preferred that the surface of the inorganic filler is subjected to silane coupling or titanium coupling. For the surface treatment, the surface of the filler is preferably treated with a surface modifier having a functional group capable of reacting with the binder species.

The inorganic filler is preferably added in an amount of 10% to 90% by weight, more preferably 20% to 80% by weight, particularly preferably 30% to 75% by weight, based on the total solid content of the antiglare layer.

The inorganic filler does not cause scattering because the inorganic filler has a particle diameter sufficiently smaller than the wavelength of light. A dispersion prepared by dispersing the filler in the binder polymer has uniform optical properties.

### [Structure of the Antiglare Film]

Generally, the antiglare film of the present invention has, at its simplest form, a structure in which the antiglare layer is formed on the transparent support by coating.

Examples of preferred layer structures of the antiglare film according to the present invention include, but are not particularly limited to, the following structures.

Support/antiglare layer

Support/hard coat layer/antiglare layer

Support/antiglare layer/hard coat layer

Support/antiglare layer/low refractive index layer

Support/hard coat layer/antiglare layer/low refractive index layer

Support/antiglare layer/hard coat layer/low refractive index layer

### [Low Refractive Index Layer]

A low refractive index layer may also be formed on the antiglare layer. The low refractive index layer has a lower refractive index than that of the antiglare layer. The thickness of the low refractive index layer is preferably from 50 nm to 200 nm, more preferably from 70 nm to 150 nm, most preferably from 80 nm to 120 nm.

The low refractive index layer has a lower refractive index than that of the underlying layer. The refractive index of the low refractive index layer is preferably from 1.20 to 1.55, more preferably 1.25 to 1.46, particularly preferably from 1.30 to 1.40. The thickness of the low refractive index layer is preferably from 50 to 200 nm, more preferably 70 to 100 nm. The low refractive index layer is preferably formed by curing a suitable curable composition.

Examples of preferred curable compositions for the formation of the low refractive index layer include:

(1) A composition containing a fluorine-containing compound having a crosslinkable or polymerizable functional group;
(2) A composition containing a hydrolysis condensation product of a fluorine-containing organosilane material as the main component; and
(3) A composition containing a monomer having two or more ethylenically unsaturated groups and inorganic fine particles (particularly preferred are inorganic fine particles having a hollow structure).

It is also preferred for the compositions (1) and (2) to contain inorganic fine particles. The use of inorganic fine particles having a low refractive index and a hollow structure is particularly preferred in view of the lowered refractive indices, the amount of the inorganic fine particles added and the adjustment of refractive indices.

### (1) A Fluorine-Containing Compound Having a Crosslinkable or Polymerizable Functional Group

As the fluorine-containing compound having a crosslinkable or polymerizable functional group, there may be exemplified a copolymer of a fluorine-containing monomer and a monomer having a crosslinkable or polymerizable functional group. Specific examples of such fluorine-containing polymers are disclosed in JP-A-2003-222702 and JPA-2003-183322.

The polymer may be used in combination with a curing agent having a polymerizable unsaturated group, as described in JP-A-2000-17028. The polymer may also be used in combination with a compound having a fluorine-containing polyfunctional polymerizable unsaturated group, as described in JP-A-2002-145952. Examples of compounds having a polyfunctional polymerizable unsaturated group include monomers having two or more ethylenically unsaturated groups, as already explained in the curable resin compound of the antiglare layer. Hydrolysis condensation products of the organosilanes described in JP-A-2004-170901 are also preferred, and hydrolysis condensation products of (meth)acryloyl group-containing organosilanes are particularly preferred. Combinations of these compounds, particularly, the compound having a polymerizable unsaturated group in the polymer main body thereof, is very effective in improving the scratch resistance of the antiglare film.

When the polymer is not sufficiently curable, blending with a crosslinkable compound is needed for curability. In the case of the polymer containing a hydroxyl group in the main body thereof, it is preferred to use various amino compounds as curing agents. The amino compounds as crosslinkable compounds contain two or more same or different groups selected from hydroxyalkylamino groups and alkoxyalkylamino groups. Specific examples of such amino compounds include melamine compounds, urea compounds, benzoguanamine compounds, and glycoluril compounds. These compounds are preferably cured using organic acids or salts thereof.

### (2) A Composition Containing a Hydrolysis Condensation Product of a Fluorine-Containing Organosilane Material as the Main Component

The composition containing a hydrolysis condensation product of a fluorine-containing organosilane compound as the main component is also preferred because it has low refractive index and exhibits high hardness on the surface of the coated film. Preferred is a condensation product of a compound containing a hydrolyzable silanol group at one or both ends of a fluorinated alkyl group and tetraalkoxysilane. Specific compositions are described in JP-A-2002-265866 and Japanese Patent No. 317152.

### (3) A Composition Containing a Monomer Having Two or More Ethylenically Unsaturated Groups and Inorganic Fine Particles Having a Hollow Structure

Another preferred embodiment is a low refractive index layer including low refractive index particles and a binder. The low refractive index particles may be organic or inorganic particles, preferably those having cavities therein. Specific examples of such hollow particles include silica particles described in JP-A-2002-79616. The refractive index of the particles is preferably from 1.15 to 1.40, and more preferably from 1.20 to 1.30. The binder may be a monomer having two or more ethylenically unsaturated groups mentioned in the section of the antiglare layer.

It is preferred to add the above-described photo-radical polymerization initiator or thermal radical polymerization initiator to the composition for the low refractive index layer. When the composition contains a radical polymerizable compound, the polymerization initiator may be used in an amount of 1 to 10 parts by weight, preferably 1 to 5 parts by weight, based on the compound.

The low refractive index layer may further use inorganic particles. Fine particles can be used that have a particle diameter corresponding to 15% to 150%, preferably 30% to 100%, more preferably 45% to 60%, of the thickness of the low refractive index layer. Within this range, scratch resistance can be imparted.

One or more suitable additives known in the art, such as polysiloxane-based or fluorine-based antifouling agents and lubricants, may be added to the low refractive index layer to impart desired characteristics, including antifouling, water resistance, chemical resistance, and slidability.

The additives having a polysiloxane structure are preferably reactive group-containing polysiloxanes. Examples of such polysiloxane additives include: “KF-100T”, “X-22-169AS”, “KF-102”, “X-22-37011E”, “X-22-164B”, “X-22-5002”, “X-22-173B”, “X-22-174D”, “X-22-167B” and “X-22-161AS” (trade names of Shin-Etsu Chemical Co., Ltd.); “AK-5”, “AK-30” and “AK-32” (trade names of Toagosei Co., Ltd.); and “Silaplain FM0725” and “Silaplain FM0721” (trade names of Chisso Corporation). The use of the silicone compounds described in Tables 2 and 3 in JP-A-2003-112383 is also preferred.

The fluorine-based compounds preferably have a fluoroalkyl group. The fluoroalkyl group preferably has 1 to 20 carbon atoms, more preferably 1 to 10 carbon atoms. The fluoroalkyl group may be straight, branched or alicyclic in structure. The fluoroalkyl group may have an ether bond. Examples of straight fluoroalkyl groups include —CF₂CF₃, —CH₂(CF₂)₄H, —CH₂(CF₂)₈CF₃ and —CH₂CH₂(CF₂)₄H. Examples of branched fluoroalkyl groups include —CH(CF₃)₂, —CH₂CF(CF₃)₂, —CH(CH₃)CF₂CF₃ and —CH(CH₃)(CF₂)₅CF₂H. Examples of preferred alicyclic fluoroalkyl groups include 5-membered rings and 6-membered rings, such as perfluorocyclohexyl, perfluorocyclopentyl, alkyl groups substituted with perfluorocyclohexyl, and alkyl groups substituted with perfluorocyclopentyl. Examples of fluoroalkyl groups having an ether bond include —CH₂OCH₂CF₂CF₃, —CH₂CH₂OCH₂C₄F₈H, —CH₂CH₂OCH₂CH₂C₈F₁₇ and —CH₂CH₂OCF₂CF₂OCF₂CF₂H. A plurality of fluoroalkyl groups may be included in the same molecule.

It is preferred that the fluorine-based compounds have one or more substituents capable of contributing to the formation of bonds and compatibility with the coating of the low refractive index layer. The substituent may be the same as or different from each other. Examples of preferred substituents include acryloyl, methacryloyl, vinyl, aryl, cinnamoyl, epoxy, oxetanyl, hydroxyl, polyoxyalkylene, carboxyl and amino groups. The fluorine-based compounds may form polymers or oligomers with compounds containing no fluorine atom. There is no particular restriction on the molecular weight of the fluorine-based compounds. The content of fluorine atoms in the fluorine-based compounds is not particularly limited but is preferably from 20% by weight or more, particularly preferably from 30% to 70% by weight, most preferably from 40% to 70% by weight. Examples of preferred fluorine-based compounds include, but are not limited to; R-2020, M-2020, R-3833, M-3833, OPTOOL DAC (trade names of Daikin Industries Ltd.); and Megafac F-171, F-172, F-179A, Defensa MCF-300 and MCF-323 (trade names of DIC Corporation).

These polysiloxane-based fluorinated compounds and compounds having a polysiloxane structure are preferably added in an amount of 0.1% to 10% by weight, particularly preferably 1% to 5% by weight, based on the total solid content of the low refractive index layer.

### [Hard Coat Layer]

The antiglare film of the present invention may include a hard coat layer to further impart physical strength of the film, in addition to the antiglare layer. The hard coat layer may be a laminate of two or more layers.

The hard coat layer typically has a thickness of about 0.5 μm to about 50 μm, preferably 1 μm to 20 μm, more preferably 2 μm to 10 μm, most preferably 3 μm to 7 μm. Within this range, the antiglare film is sufficiently durable and resistant to impact. The hard coat layer preferably has a strength of H or higher, more preferably 2H or higher, most preferably 3H or higher, as measured by a pencil hardness test. A smaller amount of a test piece of the hard coat layer abraded after the taper test according to JIS K5400 is more preferred.

The hard coat layer is preferably formed by crosslinking or polymerization of an ionizing radiation-curable resin compound. For example, the hard coat layer can be formed by coating a transparent plastic film substrate with a coating composition including an ionizing radiation-curable polyfunctional monomer or polyfunctional oligomer, and crosslinking or polymerizing the coating composition. The functional groups of the ionizing radiation-curable polyfunctional monomer or polyfunctional oligomer are preferably those that can be polymerized by light, electron beam or radiation. Photocurable functional groups are preferred. Examples of such photocurable functional groups include unsaturated polymerizable functional groups, such as (meth)acryloyl, vinyl, styryl and allyl groups. Of these, (meth)acryloyl groups are preferred.

The hard coat layer may contain mat particles having an average particle diameter of 1.0 μm to 10.0 μm, preferably 1.5 μm to 7.0 μm, to impart internal scattering to the film. The mat particles may be, for example, particles of an inorganic compound or resin.

A high refractive index monomer or inorganic particles or both of them may be added to a binder of the hard coat layer to control the refractive index of the hard coat layer. The addition of the inorganic particles is also effective in inhibiting curing shrinkage arising from crosslinking.

### [Transparent Support]

The transparent support is not particularly limited. For example, the transparent support is a transparent resin film, plate or sheet. As the transparent resin film, there may be used, for example, a cellulose acylate film (e.g., a cellulose triacetate film (refractive index 1.48), a cellulose diacetate film, a cellulose acetate butyrate film or a cellulose acetate propionate film), a polyethylene terephthalate film, a polyether sulfone film, a polyacrylic resin film, a polyurethane resin film, a polyester film, a polycarbonate film, a polysulfone film, a polyether film, a polymethylpentene film, a polyether ketone film or a (meth)acrylonitrile film.

Of these, a cellulose acylate film is preferred as the transparent support for its high transparency, less optical birefringence and ease of production. Due to these advantages, cellulose acylate films are generally used as protective films of polarizing plates. A cellulose triacetate film is more preferred as the transparent support. The thickness of the transparent substrate is typically adjusted to about 25 μm to about 1,000 μm. In the present invention, the transparent support is preferably a cellulose ester film. The thickness of the cellulose ester film is preferably from 30 μm to 100 μm, more preferably from 40 μm to 80 μm.

In the present invention, a cellulose acylate film using cellulose acetate having a degree of acetylation of 59.0% to 61.5% is preferred.

The term “degree of acetylation” used herein refers to an amount of acetic acid bound per unit weight of cellulose. The degree of acetylation is determined by the measurement and calculation of the degree of acetylation according to ASTM: D-817-91 (testing method of cellulose acetate, etc.). The viscosity average degree of polymerization (DP) of cellulose acylate is preferably 250 or higher, more preferably 290 or higher.

It is preferred that the cellulose acylate used in the present invention has an Mw/Mn value close to 1, in other words, a narrow molecular weight distribution. Mw represents the weight average molecular weight of the cellulose acylate and Mn represents the number average molecular weight of the cellulose acylate, as measured by gel permeation chromatography. Specifically, the Mw/Mn value of the cellulose acylate is preferably from 1.0 to 1.7, more preferably from 1.3 to 1.65, most preferably from 1.4 to 1.6.

Generally, the hydroxyl groups at the 2-, 3- and 6-positions of the cellulose acylate are not equally distributed (that is, not ⅓ for each position based on the total degree of substitution), but the degree of substitution of the hydroxyl group at the 6-position tends to be small. In the present invention, it is preferred that the degree of substitution of the hydroxyl groups at the 6-position of the cellulose acylate is greater than that of the hydroxyl groups at the 2- or 3-position. It is preferred that 32% or more of the hydroxyl groups at the 6-position with respect to the total degrees of substitution at the 2-, 3- and 6-positions are substituted with acyl groups. The degree of substitution of the hydroxyl groups at the 6-position is more preferably 33% or more, particularly preferably 34% or more. It is preferred that the degree of substitution of the acyl groups at the 6-position of the cellulose acylate is 0.88 or more. The hydroxyl groups at the 6-position may be substituted with acyl groups having three or more carbon atoms, such as propionyl, butyroyl, valeroyl, benzoyl and acryloxy groups, other than acetyl groups. The degrees of substitutions at the individual positions can be measured by NMR.

The cellulose acylate used in the present invention may be selected from those obtained by the methods described in [Synthesis Example 1] (Paragraphs “0043” to “0044”), [Synthesis Example 2] (Paragraphs “0048” to “0049”) and [Synthesis Example 3] (Paragraphs “0051” to “0052”) of JP-A-11-5851.

An inexpensive polyethylene terephthalate film is preferably used in the present invention due to its high transparency, mechanical strength, planarity, chemical resistance and moisture resistance. The transparent plastic film is more preferably treated for ease of adhesion to further improve the adhesive strength to the overlying hard coat layer. As commercially available PET films possessing optical easy-to-adhere layers, there may be exemplified COSMOSHINE A4100, A4300 (Toyobo Co., Ltd.).

[Coating method]

The constituent layers of the optical film according to the present invention can be formed by various coating methods known in the art. Examples of such coating methods include, but are not limited to, dip coating, air knife coating, curtain coating, roller coating, wire bar coating, gravure coating, slide coating, extrusion coating (die coating) (see JP-A-2003-164788), and microgravure coating. Of these, microgravure coating and die coating are preferred.

The upper distribution ratio of the light-transmitting particles in the antiglare layer according to the present invention is preferably adjusted to 45% to 99% by (1) a method for forming two layers by simultaneous coating or (2) a method for coating and drying in a state in which the surface of the coating film (coated surface) is directed downwardly (the surface of the coating film is inclined at an angle of 0° to smaller than 90° relative to the horizontal direction, that is, the normal line of the coated surface is inclined at an angle of 0° to smaller than 90° relative to the vertically downward direction). It is preferred that the coated surface is directed downwardly when drying after a coating process. The angle between the normal line of the coated surface and the vertically downward direction is preferably from 0° to 40°.

(1) Preferred methods for forming two or more layers by simultaneous coating using one coating apparatus are described in Japanese Patent No. 4277465, JP-A-2007-164166, JP-A-2003-260400, JP-A-7-108213 and JP-A-2007-121426. A particularly preferred method using a slot die coater is described in JP-A-2003-260400.

When it is intended to form two or more layers by simultaneous coating, a coating composition for the formation of the lower layer (toward the transparent support) is preferably used in an amount of 10 cc/m² to 100 cc/m², more preferably 15 cc/m² to 70 cc/m², even more preferably 20 cc/m² to 50 cc/m², while a coating composition for the formation of the layer other than the lower layer is preferably used in an amount of 5 cc/m² to 50 cc/m², more preferably 6 cc/m² to 40 cc/m², even more preferably 10 cc/m² to 30 cc/m². Within these ranges, excessive mixing of the solutions between the layers does not occur when simultaneous coating. The ratio of the coating amount of the upper layer (opposite to the transparent support) to the coating amount of the lower layer on the basis of solid content is preferably from 50:50 to 5:95, more preferably from 30:70 to 10:90. The thickness of the upper layer after curing is preferably from 1 μm to 6 μm, more preferably from 2 μM to 4 μm. The thickness of the lower layer after curing is from 3 μm to 10 μm, more preferably from 5 μm to 8 μm.

The coating composition for the formation of the upper layer includes at least a curable resin compound (A) and light-transmitting particles (B). The coating composition for the formation of the lower layer includes at least a curable resin compound (A), and optionally light-transmitting particles (B). Each of the two compositions may further include one or more additives explained in the coating composition for the formation of the antiglare layer. The content of the light-transmitting particles in the upper layer is preferably from 2% to 15% by weight, more preferably from 4% to 10% by weight, based on the solid content of the upper layer. The content of the light-transmitting particles in the lower layer is preferably from 0% to 10% by weight, more preferably from 0% to 5% by weight, based on the solid content of the lower layer.

The viscosity of the coating composition for the formation of the lower layer is preferably from 1 mPa·S to 200 mPa·S, more preferably from 2 mPa·S to 100 mPa·S, even more preferably from 5 mPa·S to 50 mPa·S. The viscosity of the coating composition for the formation of the layer other than the lower layer is preferably 50 mPa·S or lower, more preferably 30 mPa·S or lower, and even more preferably 20 mPa·S or lower. Any method may be used without limitation to adjust the viscosities of the coating solutions. For example, the use of the thickener and thixotropic agent described in JP-A-2007-233185 may be considered.

When the two or more layers are coated simultaneously, the particles of the upper layer are suitably buried in the lower layer. This ensures a high upper distribution ratio of the antiglare film while inhibiting glare. On the other hand, the two or more layers may be formed by successive coating. In this case, the particles of the upper layer are not buried in the lower layer. Even when the upper distribution ratio is adjusted to 45% or more, the feeling of the rough surface may be poor and glare inhibition may be insufficient.

### [Drying and Curing Conditions]

An explanation will be given regarding drying and curing processes after coating for the formation of the antiglare layer, etc. with reference to the following preferred examples.

It is effective to cure by a combination of irradiation with ionizing radiation and heat treatment before, simultaneously with or after the irradiation.

The followings are some patterns for the production of the antiglare layer but the present invention is not limited thereto.

(In the following table, “-” implies that heat treatment is not performed)

TABLE 1

| | | | Simultaneous with | | |
|---|---|---|---|---|---|
| | Before irradiation | → | irradiation | → | After irradiation |
| (1) | Heat treatment | → | Curing by | → | — |
| | | | ionizing radiation | | |
| (2) | Heat treatment | → | Curing by | → | Heat treatment |
| | | | ionizing radiation | | |
| (3) | — | → | Curing by | → | Heat treatment |
| | | | ionizing radiation | | |

It is also preferred to perform heat treatment simultaneously with curing by ionizing radiation.

In the present invention, it is preferred to perform heat treatment in combination with ionizing radiation irradiation, as described above. Conditions for the heat treatment are not specifically limited so long as the constituent layers, including the support and the antiglare layer, of the antiglare film are not damaged. The temperature for the heat treatment is preferably from 40° C. to 150° C., more preferably from 50° C. to 130° C., most preferably from 60° C. to 110° C. The heat treatment may be performed such that the solid content is adjusted to preferably 70% or higher by weight, more preferably 80% or higher by weight, within 20 sec after coating.

The time required for the heat treatment varies depending on various factors, such as the molecular weights and viscosities of the components used and the interactions the components with the other components. The heat treatment is performed for 15 sec to 1 hr, preferably 20 sec to 30 min, most preferably 30 sec to 5 min.

There is no particular restriction on the kind of the ionizing radiation. The ionizing radiation may be, for example, X-ray, electron beam, UV light, visible light or infrared light. UV light is widely used. For example, when the coating layer is UV curable, it is preferred to cure the constituent layers by irradiation with UV light having an energy of 10 mJ/cm² to 1,000 mJ/cm² under a UV lamp. The energy may be applied in a single dose or in divided doses. It is particularly preferred to irradiate UV light in two or more divided doses taking into consideration less performance non-uniformity in the in-plane of the coating film, a better surface shape and a better feeling of the rough surface. It is preferred that UV light having a low energy of 150 mJ/cm² or less is first irradiated at an initial stage, and then, UV light having a high energy of 50 mJ/cm² or more are irradiated. It is preferred to irradiate UV light having a higher energy at a later stage, rather than an initial stage.

### [Polarizing Plate]

The present invention provides a polarizing plate including a polarizing film and protective films arranged at both sides of the polarizing film. The antiglare film of the present invention is used as at least one of the protective films. Due to this construction, the polarizing plate has antiglare properties.

The antiglare film of the present invention may be used as one of the protective films and a general cellulose acetate film may be used as the other protective film. The cellulose acetate film is preferably one that is produced by a solution film-forming process and is stretched to an elongation of 10% to 100% in the form of a roll film in the widthwise direction.

According to a preferred embodiment, the protective film other than the polarizing film is an optical compensation film having an optical compensation layer including an optically anisotropic layer. The use of the optical compensation film (retardation film) can improve the viewing angle of a screen of a liquid crystal display. The optical compensation film may be any of those known in the art. The optical compensation film described in JP-A-2001-100042 is preferred due to its wide viewing angle.

Iodine-based polarizing films, dye-based polarizing films using dichroic dyes and polyene-based polarizing films are known. The iodine-based polarizing films and dye-based polarizing films are generally produced using polyvinyl alcohol films

The polarizing film may be any of those in the art or may be a piece cut from a long polarizing film whose absorption axis is not parallel or perpendicular to the lengthwise direction. The long polarizing film is manufactured by the following procedure.

First, a tension is applied to a polymer film, such as a polyvinyl alcohol film, continuously supplied while maintaining both ends of the polymer film using retaining means. The polymer film is stretched to an elongation of at least 1.1 to 20.0 times in the transverse direction thereof. During stretching, the difference in running speed between the lengthwise directions of the retaining apparatuses at both ends of the film is maintained within 3%. The stretching is performed by bending the running direction of the film in a state in which both ends of the film is maintained such that the running direction of the film at the outlet of the process for maintaining both ends of the film is inclined at an angle of 20° to 70° relative to the actual stretching direction of the film. It is particularly preferred to adjust the inclination angle to 45° in terms of productivity.

A detailed description of a method for stretching a polymer film can be found in Paragraphs [0020] to [0030] of JP-A-2002-86554.

### [Image Display]

The antiglare film or polarizing plate of the present invention can be used in image displays, such as liquid crystal displays (LCDs), plasma display panels (PDPs), electroluminescence displays (ELDs) and cathode ray tube (CRT) displays.

### EXAMPLES

The present invention will be explained in detail with reference to the following examples but is not limited to these examples.

### (Preparation of Dispersions of Particles)

Dispersions having the compositions shown in Table 2 were prepared. Specifically, the light-transmitting resin particles were slowly added to a solution of the dispersant in methyl isobutyl ketone (MIBK) with stirring until the solid content of each of the dispersions reached 30 wt %. Stirring was continued for 30 min. The values in Table 2 represent “parts by weight” of the constituent components.

TABLE 2

| | Dispersion of particles | | | | | | | | | | |
|---|---|---|---|---|---|---|---|---|---|---|---|
| | D101 | D102 | D103 | D104 | D105 | D106 | D107 | D108 | D109 | D110 | D111 |
| MIBK | 12.8 | 12.8 | 10.5 | 10.5 | 15.8 | 13.7 | 7.4 | 5.3 | 7.4 | 12.8 | 12.8 |
| Disperbyk-66 | 0 | 0 | 2.3 | 2.3 | 3.4 | 3 | 1.6 | 1.2 | 1.6 | 0 | 0 |
| Light-transmitting | A | E | A | D | F | B | G | A | B | C | G |
| fine particles | 5.5 | 5.5 | 5.5 | 5.5 | 8.3 | 7.1 | 3.8 | 2.8 | 3.8 | 5.5 | 5.5 |
| (content) | | | | | | | | | | | |

The light-transmitting resin particles shown in Table 2 are products manufactured by Sekisui Plastics Co., Ltd.

A: 6 μm crosslinked acrylic-styrene particles (refractive index 1.520)

B: 3.5 μm crosslinked acrylic-styrene particles (refractive index 1.520)

C: 12 μm crosslinked acrylic-styrene particles (refractive index 1.520)

D: 5 μm crosslinked acrylic-styrene particles (refractive index 1.520)

E: 6 μm crosslinked acrylic-styrene particles (refractive index 1.555)

F: 2 μm crosslinked acrylic-styrene particles (refractive index 1.520)

G: 6 μm crosslinked acrylic particles (refractive index 1.500)

Disperbyk-166 (Trade name, amine value 20 KOH/g) is a polymer compound manufactured by BYK-Chemie.

(Preparation of Coating Solutions for Antiglare Layers)

The constituent components were added in amounts shown in Table 3 and filtered through a polypropylene filter (pore diameter 30 μm) to prepare coating solutions A101-A121 for antiglare layers. The values in Table 3 represent “parts by weight” of the constituent components.

TABLE 3

| | Coating solution for antiglare layer | | | | | | | | | | | | |
|---|---|---|---|---|---|---|---|---|---|---|---|---|---|
| | A101 | A102 | A103 | A104 | A105 | A106 | A107 | A108 | A109 | A110 | A111 | A112 | A113 |
| PET-30 | 29.4 | 29.4 | 29.4 | 29.4 | 29.9 | 29 | 28.6 | 28.6 | 28.6 | 26.7 | 27.5 | 29.8 | 28.6 |
| Biscoat-360 | 17.6 | 17.6 | 17.6 | 17.6 | 17.9 | 17.4 | 17.2 | 17.2 | 17.2 | 16 | 16.5 | 17.9 | 17.2 |
| UV1700B | 0 | 0 | 0 | 0 | 0 | 0 | 0 | 0 | 0 | 0 | 0 | 0 | 0 |
| Methyl isobutyl | 25.0 | 15.6 | 15.6 | 15.6 | 18.7 | 8.9 | 11.2 | 11.2 | 11.2 | 5.9 | 8 | 14.3 | 11.2 |
| ketone | | | | | | | | | | | | | |
| Methyl ethyl | 4.0 | 13.4 | 13.4 | 13.4 | 13.4 | 20.2 | 18.6 | 18.6 | 18.6 | 17.7 | 18.1 | 19 | 18.6 |
| ketone | | | | | | | | | | | | | |
| CAB | 3.8 | 3.8 | 3.8 | 3.8 | 0 | 3.8 | 3.8 | 3.8 | 3.8 | 3.8 | 3.8 | 3.8 | 3.8 |
| 20 wt % MIBK | | | | | | | | | | | | | |
| solution | | | | | | | | | | | | | |
| Irgacure 819 | 0 | 0 | 0 | 0 | 0 | 0.6 | 0.6 | 0.6 | 0.6 | 0.6 | 0.6 | 0.6 | 0.6 |
| Irgacure 907 | 1.7 | 1.7 | 1.7 | 1.7 | 1.7 | 1.7 | 1.7 | 1.7 | 1.7 | 1.7 | 1.7 | 1.7 | 1.7 |
| Dispersion of | D101 | D102 | D101 | D101 | D101 | D101 | D103 | D104 | D104 | D105 | D106 | D107 | D103 |
| particles | 18.3 | 18.3 | 18.3 | 18.3 | 18.3 | 18.3 | 18.3 | 18.3 | 18.3 | 27.5 | 23.8 | 12.8 | 18.3 |
| (Content) | | | | | | | | | | | | | |
| SP-13 | 0.2 | 0.2 | 0.2 | 0.2 | 0.2 | 0.2 | 0.2 | 0.2 | 0.2 | 0.2 | 0.2 | 0.2 | 0.2 |
| Viscosity | 8 | 8 | 8 | 8 | 5 | 8 | 8 | 9 | 8 | 8 | 8 | 8 | 8 |
| (mPa · s) | | | | | | | | | | | | | |
| Solid content | 55 | 55 | 55 | 55 | 55 | 55 | 55 | 55 | 55 | 55 | 55 | 55 | 55 |
| (wt %) | | | | | | | | | | | | | |

| | Coating solution for antiglare layer | | | | | | | | |
|---|---|---|---|---|---|---|---|---|---|
| | A114-1 | A114-2 | A115-1 | A115-2 | A117 | A118 | A119 | A120 | A121 |
| PET-30 | 30.6 | 33.1 | 29.8 | 33.1 | 29.4 | 17 | 20.8 | 31.6 | 8.6 |
| Biscoat-360 | 18.3 | 19.9 | 17.9 | 19.9 | 17.6 | 30 | 12.5 | 18.7 | 17.2 |
| UV1700B | 0 | 0 | 0 | 0 | 0 | 0 | 0 | 0 | 23 |
| Methyl isobutyl | 16.4 | 23.6 | 14.3 | 23.6 | 15.6 | 15.6 | 23.1 | 7.2 | 11.2 |
| ketone | | | | | | | | | |
| Methyl ethyl | 19.4 | 20.2 | 19 | 20.2 | 13.4 | 13.4 | 25.8 | 16.1 | 18.6 |
| ketone | | | | | | | | | |
| CAB | 3.8 | 1.4 | 3.8 | 1.4 | 3.8 | 3.8 | 2.8 | 4.2 | 3.8 |
| 20 wt % MIBK | | | | | | | | | |
| solution | | | | | | | | | |
| Irgacure 819 | 0.6 | 1.7 | 0.6 | 1.7 | 0 | 0 | 0.4 | 0.6 | 0.6 |
| Irgacure 907 | 1.7 | 0 | 1.7 | 0 | 1.7 | 1.7 | 1.2 | 1.8 | 1.7 |
| Dispersion of | D108 | — | D109 | — | D110 | D111 | D103 | D103 | D103 |
| particles | 9.2 | 0 | 12.8 | 0 | 18.3 | 18.3 | 13.3 | 20.0 | 15.3 |
| (Content) | | | | | | | | | |
| SP-13 | 0.2 | 0.2 | 0.2 | 0.2 | 0.2 | 0.2 | 0.1 | 0.2 | 0.2 |
| Viscosity | 8 | 6 | 9 | 6 | 8 | 8 | 4 | 15 | 8 |
| (mPa · s) | | | | | | | | | |
| Solid content | 55 | 55 | 55 | 55 | 55 | 55 | 40 | 60 | 55 |
| (wt %) | | | | | | | | | |

The following compounds were used as the components.

PET-30: Mixture of pentaerythritol triacrylate and pentaerythritol tetraacrylate [Nippon Kayaku Co., Ltd.]
Biscoat 360: Trimethylolpropane EO-added triacrylate [Osaka Organic Chemical Industry Ltd.]
UV1700B: Urethane acrylate (Nippon Synthetic Chemical Industry Co., Ltd.)
CAB: Cellulose acetate butyrate 531-1 [Eastman Kodak]
Irgacure 819: Phosphine oxide photopolymerization initiator [BASF]
Irgacure 907: Acetophenone photopolymerization initiator [BASF]
SP-13: Fluorinated surfactant represented by the following formula

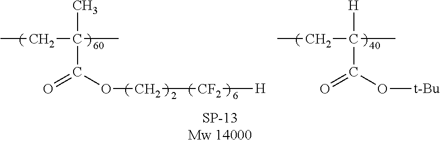

### (Formation of Antiglare Layers by Coating)

A triacetyl cellulose film having a thickness of 80 μm, 60 μm or 40 μm was wound in a roll form. Antiglare film samples 101-121 were manufactured using coating solutions A101-A121, respectively. Each of samples A101-A106 and A108-A120 was used for the 80 μm thick triacetyl cellulose film, sample A107 was used for the 60 μm thick triacetyl cellulose film, and sample A121 was used for the 40 μm thick triacetyl cellulose film.

Specifically, each of the coating solutions was coated on the corresponding triacetyl cellulose film at a feed rate of 30 m/min by the die coating process using a slot die described in Example 1 of JP-A-2006-122889, and dried at 60° C. for 150 sec. Thereafter, the dried coating layer was cured by irradiation with ultraviolet light having an illuminance of 400 mW/cm² and a dose of 150 mJ/cm² using an air-cooled metal halide lamp (Eye Graphics Co., Ltd.) of 160 W/cm at an oxygen concentration of about 0.1% under a nitrogen purge to form an antiglare layer. The resulting film was wound. Each of samples 101-112 and 117-120 was fed such that the coated surface of the corresponding coating solution was inclined upwardly in the vertical direction and was dried until the solid content reached 70 wt % in a state in which the normal line of the coated surface was 0° to 20° relative to the upwardly vertical direction (25 sec were taken for the drying of sample 101 until the solid content reached 70 wt % after coating, 22 sec for samples 102-105, and 17 sec for the other samples). Thereafter, the samples were irradiated with UV light, followed by winding. The wind velocities were adjusted such that 26 sec were taken until the solid content of sample 119 reached 70 wt % and 10 sec for sample 120.

Each of samples 113 and 121 was fed such that the coated surface was inclined upwardly in the vertical direction and was dried until the solid content reached 70 wt % in a state in which the normal line of the coated surface was 0° to 20° relative to the upwardly vertical direction (12 sec were taken for the drying of the sample until the solid content reached 70 wt %). Thereafter, the samples were irradiated with UV light, followed by winding.

Antiglare film 114 was produced by the following procedure. First, coating solution 114-2 and coating solution 114-1 were simultaneously coated on the transparent support at a feed rate of 30 m/min using the slot die coater described in JP-A-2003-260400 until the thickness of a lower layer in contact with the transparent support after curing reached 7 μm and the thickness of an upper layer on the lower layer after curing reached 4 μm, respectively, and dried at 60° C. for 150 sec. Thereafter, the dried coating layer was cured by irradiation with ultraviolet light having an illuminance of 400 mW/cm² and a dose of 150 mJ/cm² using an air-cooled metal halide lamp (Eye Graphics Co., Ltd.) of 160 W/cm at an oxygen concentration of about 0.1% under a nitrogen purge to form an antiglare layer. The resulting film was wound. The antiglare layer was fed such that the coated surface was inclined upwardly in the vertical direction and was dried until the solid content reached 70 wt % in a state in which the normal line of the coated surface was 0-20° relative to the upwardly vertical direction (15 sec were taken until the solid content reached 70 wt % after coating). Thereafter, the antiglare layer was irradiated with UV light, followed by winding. Antiglare film 115 was produced in a similar manner to antiglare film 114. Coating solution 115-2 and coating solution 115-1 were simultaneously coated until the thickness of a lower layer after curing reached 4 μm and the thickness of an upper layer after curing reached 2 μm, respectively, followed by drying and curing to produce antiglare film 115.

In the same manner as in the production of sample 101, solution 115-2 was coated on the transparent substrate until the thickness after curing reached 4 μm, followed by drying and curing. Thereafter, solution 115-1 was coated on the cured layer until the thickness reached 2 μm, dried and cured to produce antiglare film 116.

### (Saponification of Antiglare Films)

Antiglare films 101-121 were subjected to saponification and drying under the following conditions.

Alkali bath: 1.5 mol/dm³ aqueous solution of sodium hydroxide at 55° C. for 120 sec
First water washing bath: Tap water for 60 sec
Neutralization bath: 0.05 mol/dm³ sulfuric acid at 30° C. for 20 sec
Second water washing bath: Tap water at 60 sec

### Drying: 120° C., 60 sec

### (Manufacture of Front Polarizing Plates)

Triaceyl cellulose films were dipped in a 1.5 mol/L aqueous solution of sodium hydroxide at 55° C. for 2 min, neutralized, and washed. Antiglare films 101-121 were saponified. Iodine was adsorbed to polyvinyl alcohol, which was then stretched to produce polarizers. One of the triaceyl cellulose films and one of antiglare films 101-121 were adhered to both sides of one of the polarizers to protect the polarizer, completing the manufacture of a front polarizing plate. At this time, the thickness of the triacetyl cellulose film was the same as that of the corresponding antiglare film.

### (Manufacture of Rear Polarizing Plates)

Rear polarizing plates were manufactured in the same manner as in the manufacture of the front polarizing plates, except that optical compensation films were used instead of the antiglare films. The optical compensation films were produced by the following method.

### (Production of Optical Compensation Films)

A doping solution for an inner layer and a doping solution for an outer layer were prepared to have the following compositions.

Composition of doping solution for inner layer:

| Cellulose acetate C-1 | 100 | parts by weight |
|---|---|---|
| (Degree of acetylation 2.81, | | |
| Number average molecular weight 88,000) | | |
| Retardation developer | 7 | parts by weight |
| (represented by the following formula) | | |
| 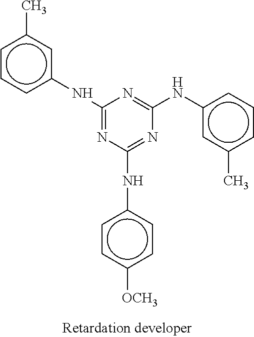 | | |
| Polymer P-2 (as below) | 9.0 | parts by weight |
| Blueing dye | 0.000078 | parts by weight |
| (represented by the following formula) | | |
| 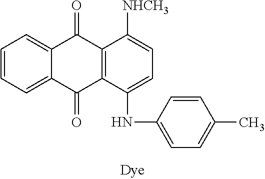 | | |
| Dichloromethane | 423.9 | parts by weight |
| Methanol | 63.3 | parts by weight |

Composition of doping solution for outer layer:

| | | |
|---|---|---|
| Cellulose acetate C-1 | 100 | parts by weight |
| (Degree of acetylation 2.81, | | |
| Number average molecular weight 88,000) | | |
| Retardation developer (as above) | 7 | parts by weight |
| Polymer P-2 (as below) | 9.0 | parts by weight |
| Blueing dye | 0.000078 | parts by weight |
| (represented by the following formula) | | |
| Silica particles | 0.14 | parts by weight |
| (average particle diameter 16 nm, | | |
| AEROSIL R972, Nippon Aerosil Co., Ltd.) | | |
| Dichloromethane | 424.5 | parts by weight |
| Methanol | 63.4 | parts by weight |

Polymer P-2: Polycondensation product (number average molecular weight 900) including dicarboxylic acid residues of TPA/PA/SA/AA (= 45/5/30/20 (mol %)) and diol residues of ethylene glycol (100 mol %) (TPA is terephthalic acid, PA is phthalic acid, SA is sebacic acid, and AA is adipic acid). Both ends of the polycondensation product are capped with acetyl ester residues.

The doping solutions for outer and inner layers were uniformly and simultaneously co-cast to a width of 2,000 mm on a stainless steel band support using a band casting apparatus to form a trilayer structure consisting of an outer layer toward the support surface, an inner layer and an outer layer toward the air interface. After the solvents were evaporated until 40 wt % of the solvents was left on the stainless steel band support, the film was peeled off from the stainless steel band support. A tension was applied during peeling to stretch the film to an elongation of 1.02 times in the machine direction (MD). Subsequently, the film was stretched to an elongation of 1.22 times at a rate of 4 5%/min in the transverse direction (TD) in a state in which both ends of the film were grasped with a tenter. 30 wt % of the solvents remained at the initial stage of stretching. After stretching, the film was fed to and dried in a drying zone at 115° C. for 35 min. After drying, the film was slit to widths of 1,340 mm to obtain cellulose acylate optical compensation films having total thicknesses of 60 μm and 40 μm. In each of the optical compensation films, the outer layer toward the support, the inner layer and the outer layer toward the air interface were in a film thickness ratio of 3:94:3.

### (Fabrication of Liquid Crystal Displays)

Front and rear polarizing plates and a retardation film were removed from a VA mode liquid crystal display (LC-32DZ3, Sharp Corporation). One of the triacetyl cellulose films as a front polarizing plate and one of the optical compensation films as a rear polarizing plate were arranged to direct toward liquid crystal cells and were adhered such that the transmission axis matched the polarizing plates of the original display product, completing the fabrication of a liquid crystal display having the antiglare film. The optical compensation film as the rear polarizing plate had the same thickness as that of the triacetyl cellulose film used in the front polarizing plate.

### (Evaluation of the Antiglare Films and Liquid Crystal Displays)

The following physical properties of the antiglare films and the liquid crystal displays were evaluated.

### <1> Pencil Hardness

The pencil hardness of each of the antiglare films were evaluated in accordance with the pencil hardness test method specified in JIS-K5400. The antiglare film was judged to be “passed (O)” when the pencil hardness was 2H or higher and “failed (x)” when the pencil hardness was lower than 2H.

### <2> Darkroom Contrast

Each of the antiglare films was mounted on a liquid crystal TV (LC-32DZ3, Sharp Corporation). A spectroradiometer (SR-UL1R, TOPCON) was used to measure the contrast of the antiglare film. Given that the contrast value of a triacetyl cellulose film without any antiglare layer was 100, the contrast value of the antiglare film was calculated and evaluated based on the following criteria.

Contrast≧97: A

### 95≦Contrast<97: B

### 93≦Contrast<95: C

### Contrast<93: D

### <3> Glare

Each of the antiglare films was mounted on a liquid crystal TV (LC-32DZ3, Sharp Corporation). In a state in which green beta was marked, a visual evaluation was made as to the extent that partial enlargement/reduction of B, G and R pixels was ununiformly observed by the naked eye (glare), based on the following criteria.

Glare was impossible to recognize: A
Glare was possible to recognize but was ignorable: B
Glare was possible to recognize but was nearly ignorable: C
Glare was possible to recognize and was not ignorable: D
Glare was possible to recognize and was not ignorable at all: E

### <4> Antiglare Properties

Each of the antiglare films was mounted on a liquid crystal TV (LC-32DZ3, Sharp Corporation). The degree of glare in black display was visually evaluated based on the following criteria.

Glare was ignorable: A
Glare was nearly ignorable: B
Glare was slightly offensive: C
Glare was not ignorable: D

### <5> Total Haze and Internal Haze

[1] The total haze values (H) of the antiglare films were measured in accordance with JIS-K7136. A haze meter (NDH2000, Nippon Denshoku Industries Co., Ltd.) was used for the haze measurement.
[2] Several drops of an immersion oil for microscopes (Immersion Oil Type A, Nikon, refractive index n=1.515) were dropped on both surfaces of one of the light-diffusing films. The film was interposed between two 1 mm thick glass plates (Micro-slide glass, product No. S9111, MATSUNAMI) and was completely in tight contact with the glass plates. The haze of the resulting structure was measured in a state in which the surface haze was removed. Separately, the haze of a structure in which the silicone oil only was filled between the two glass plates was measured. The internal haze (Hin) of the film was calculated by subtracting the haze of the latter structure from the haze of the former structure.

### <6> Surface Shape (Amplitudes at Wavelengths 50 μm and 100 μm)

The surface profile of irregularities of each of the antiglare films was measured using Vertscan2.0 (lens magnification: 10×) and analyzed by Fast Fourier transformation to determine amplitudes at wavelengths 50 μm and 100 μm.

### <7> Surface Roughness

The arithmetic average surface roughness (Ra) and the average interval of irregularities of each of the antiglare films were derived from a stylus surface roughness tester (Surfcorder SE3500, Kosaka Laboratory Ltd.) in accordance with the procedure specified in JIS-B0601 (1994).

### <8> Integrated Reflectance

Each of the antiglare films was joined to a polarizing plate of a cross nicol. The spectral reflectance (%) of the resulting structure was measured at an angle of incidence of 5° in the wavelength range of 380 nm to 780 nm using a spectrophotometer with an integrating sphere (JASCO Corporation). The integrating sphere reflectance (%) of the antiglare film at 450 nm to 650 nm was used.

<9> Upper Distribution ratio

The cross section of each of the antiglare films was cut in the thickness direction of the antiglare layer and observed under an optical microscope. The upper distribution ratio of the particles was calculated from the thickness of the antiglare layer and the average location of 100 particles present in the antiglare layer.

### <10> Degree of Particle Aggregation

An image of each of the antiglare films was taken using a transmission optical microscope. The total member of the particles and the number of domains in an area of 1 mm² were counted. The degree of particle aggregation was calculated by the following equation.

Degree of particle aggregation=(the total number of the particles present in the antiglare layer in the in-plane direction)/(the number of domains formed by the particles present in the antiglare layer in the in-plane direction)

Table 4 shows the results of evaluation of antiglare films 101-121, and Table 5 shows the results of evaluation of the polarizing plates and image displays using antiglare films 101-121.

TABLE 4

| | | Upper | | | | | | |
|---|---|---|---|---|---|---|---|---|
| | | distribution | | | Thickness/ | Degree of | | |
| | Coating | ratio of | | Particle | particle | aggregation | Integrated | |
| | solution | particles | Thickness | diameter | diameter | of particles | reflectance | Haze |
| 101 | A101 | 21 | 12 | 6 | 2.0 | 1.8 | 4.6 | 2.1 |
| 102 | A102 | 23 | 12 | 6 | 2.0 | 2.4 | 4.6 | 8.5 |
| 103 | A103 | 18 | 20 | 6 | 3.3 | 4.1 | 4.6 | 1.8 |
| 104 | A104 | 100 | 5.8 | 6 | 1.0 | 1.9 | 4.6 | 4.5 |
| 105 | A105 | 35 | 12.5 | 6 | 2.1 | 2.7 | 4.6 | 1.9 |
| 106 | A106 | 45 | 12.5 | 6 | 2.1 | 1.9 | 4.6 | 1.5 |
| 107 | A107 | 46 | 12.5 | 6 | 2.1 | 1.7 | 4.6 | 1.2 |
| 108 | A108 | 49 | 7 | 5 | 1.4 | 1.7 | 4.6 | 1.4 |
| 109 | A109 | 47 | 12.5 | 5 | 2.5 | 1.8 | 4.6 | 1.1 |
| 110 | A110 | 49 | 3.8 | 2 | 1.9 | 1.8 | 4.6 | 2.1 |
| 111 | A111 | 48 | 5.6 | 3.5 | 1.6 | 1.8 | 4.6 | 1.8 |
| 112 | A112 | 45 | 13.5 | 6 | 2.3 | 1.6 | 4.6 | 2.0 |
| 113 | A113 | 85 | 11 | 6 | 1.8 | 1.7 | 4.6 | 2.3 |
| 114 | A114 | 95 | 11 | 6 | 1.8 | 1.4 | 4.6 | 2.5 |
| 115 | A115 | 97 | 6 | 3.5 | 1.7 | 1.4 | 4.6 | 2.4 |
| 116 | A115 | 100 | 6 | 3.5 | 1.7 | 1.3 | 4.6 | 2.4 |
| 117 | A117 | 47 | 17 | 12 | 1.4 | 1.5 | 4.6 | 2.1 |
| 118 | A118 | 49 | 13 | 6 | 2.2 | 1.2 | 4.6 | 1.9 |
| 119 | A119 | 45 | 12.5 | 6 | 2.1 | 1.7 | 4.6 | 1.2 |
| 120 | A120 | 49 | 13 | 6 | 2.2 | 1.7 | 4.6 | 1.2 |
| 121 | A121 | 87 | 12 | 6 | 2.0 | 1.5 | 4.6 | 2.1 |

| | | | | | Amplitude | Amplitude | |
|---|---|---|---|---|---|---|---|
| | Internal | | | Pencil | at wavelength | at wavelength | |
| | haze | Ra | Sm | hardness | of 50 μm | of 100 μm | Remarks |
| 101 | 0.3 | 0.07 | 59 | ∘ | 0.0008 | 0.0032 | Comparative |
| | | | | | | | Example |
| 102 | 6.3 | 0.09 | 61 | ∘ | 0.0025 | 0.0051 | Comparative |
| | | | | | | | Example |
| 103 | 0.4 | 0.12 | 71 | ∘ | 0.0009 | 0.0056 | Comparative |
| | | | | | | | Example |
| 104 | 0.2 | 0.21 | 72 | ∘ | 0.0041 | 0.008 | Comparative |
| | | | | | | | Example |
| 105 | 0.2 | 0.1 | 58 | ∘ | 0.0025 | 0.0035 | Comparative |
| | | | | | | | Example |
| 106 | 0.2 | 0.08 | 63 | ∘ | 0.0019 | 0.0025 | Example |
| 107 | 0.2 | 0.06 | 49 | ∘ | 0.0015 | 0.0017 | Example |
| 108 | 0.2 | 0.09 | 68 | ∘ | 0.0017 | 0.0018 | Example |
| 109 | 0.2 | 0.08 | 69 | ∘ | 0.0018 | 0.0026 | Example |
| 110 | 0.2 | 0.09 | 51 | ∘ | 0.0015 | 0.0016 | Example |
| 111 | 0.2 | 0.09 | 51 | ∘ | 0.0016 | 0.0019 | Example |
| 112 | 0.1 | 0.1 | 52 | ∘ | 0.0021 | 0.0025 | Example |
| 113 | 0.2 | 0.08 | 50 | ∘ | 0.0021 | 0.0014 | Example |
| 114 | 0.2 | 0.09 | 48 | ∘ | 0.0024 | 0.0013 | Example |
| 115 | 0.2 | 0.09 | 45 | ∘ | 0.0025 | 0.0012 | Example |
| 116 | 0.2 | 0.24 | 45 | ∘ | 0.004 | 0.0049 | Comparative |
| | | | | | | | Example |
| 117 | 0.2 | 0.13 | 61 | ∘ | 0.003 | 0.0029 | Example |
| 118 | 0.8 | 0.14 | 46 | ∘ | 0.0028 | 0.0027 | Example |
| 119 | 0.2 | 0.01 | 55 | ∘ | 0.0019 | 0.0028 | Example |
| 120 | 0.2 | 0.06 | 48 | ∘ | 0.0015 | 0.0016 | Example |
| 121 | 0.2 | 0.08 | 46 | ∘ | 0.0021 | 0.0014 | Example |

TABLE 5

| Antiglare | Antiglare | | | |
|---|---|---|---|---|
| film | properties | Glare | Contrast | Remarks |
| 101 | D | D | A | Comparative Example |
| 102 | B | E | C | Comparative Example |
| 103 | D | E | B | Comparative Example |
| 104 | A | E | B | Comparative Example |
| 105 | A | D | A | Comparative Example |
| 106 | A | C | A | Example |
| 107 | B | B | A | Example |
| 108 | B | B | A | Example |
| 109 | B | C | A | Example |
| 110 | B | B | A | Example |
| 111 | B | B | A | Example |
| 112 | A | C | A | Example |
| 113 | A | A | A | Example |
| 114 | A | A | A | Example |
| 115 | A | A | A | Example |
| 116 | A | E | A | Comparative Example |
| 117 | A | C | A | Example |
| 118 | B | C | B | Example |
| 119 | B | C | A | Example |
| 120 | B | B | A | Example |
| 121 | A | A | A | Example |

As can be seen from Tables 4 and 5, antiglare films 101-105 showed poor results in one or more parameters of antiglare properties, glare and contrast. In contrast, inventive antiglare films 106-121 showed good results in terms of antiglare properties, glare and contrast.

A low refractive index layer was formed on each of inventive antiglare films 106-121 by coating. The resulting structures produced a good feeling of black while maintaining good results in terms of antiglare properties, glare and contrast.

### [Formation of Low Refractive Index Layer by Coating]

### (Preparation of Dispersion B-1 of Inorganic Particles)

Silica fine particles having cavities therein were produced in the same manner as in Preparative Example 4 of JP-A-2002-79616, except that some of the production conditions were changed. The hollow silica fine particles in the state of an aqueous dispersion were solvent exchanged with methanol. The final solid content were adjusted to 20 wt % to obtain dispersion B containing the silica particles having an average particle diameter of 45 nm, a shell thickness of about 7 nm and a refractive index of 1.30.

15 parts by weight of acryloyloxypropyltrimethoxysilane and 1.5 parts by weight of diisopropoxy aluminum ethyl acetate were added to and mixed with 500 parts by weight of dispersion B, and 9 parts by weights of ion-exchanged water was added thereto. The mixture was allowed to react at 60° C. for 8 hr. The reaction mixture was cooled to room temperature. To the reaction mixture was added 1.8 parts by weight of acetyl acetone. The resulting mixture was solvent exchanged with methyl ethyl ketone by distillation under reduced pressure while continuously adding the methyl ethyl ketone in such an amount that the total amount of the solution was maintained almost constant. The final solid content were adjusted to 20 wt % to obtain dispersion B-1.

### (Preparation of Coating Solution for Low Refractive Index Layer)

7.6 g of a fluorine-containing polymer (P-12: fluorine-containing copolymer exemplified in JP-A-2007-293325), 1.4 g of a mixture of dipentaerythritol pentaacrylate and dipentaerythritol hexaacrylate [DPHA, Nippon Kayaku Co., Ltd.], 2.4 g of dispersion B-1, 0.46 g of a photopolymerization initiator (Irgacure 907), 190 g of methyl ethyl ketone and 48 g of propylene glycol monomethyl ether acetate were mixed with stirring, and filtered through a polypropylene filter (pore diameter 5 μm) to prepare a coating solution for a low refractive index layer.

### (Formation of Low Refractive Index Layer by Coating)

The triacetyl cellulose film, on which the antiglare layer was formed by coating, was again rolled. The coating solution for a low refractive index layer was coated on the triacetyl cellulose film at a feed rate of 30 m/min by the die coating process using a slot die, and dried at 90° C. for 75 sec. Thereafter, the dried coating layer was irradiated with ultraviolet light having an illuminance of 400 mW/cm² and a dose of 240 mJ/cm² using an air-cooled metal halide lamp (Eye Graphics Co., Ltd.) of 240 W/cm at an oxygen concentration of 0.01-0.1% under a nitrogen purge to form a 100 nm thick low refractive index layer, completing the production of an antiglare film. The antiglare film was wound. The low refractive index layer had a refractive index of 1.46.

What is claimed is:

1. An antiglare film comprising: a transparent support; and an antiglare layer formed from a composition comprising a curable resin compound (A) and light-transmitting particles (B),
wherein
the antiglare layer has a thickness, wherein a value obtained by dividing the thickness by an average particle diameter of the light-transmitting particle (B) is from 1.1 to 3.0,
the antiglare film has a total haze value of 0.5% to 5.0% and an internal haze value of 1.5% or less, and
the light-transmitting particles (B) have an upper distribution ratio in the antiglare layer, calculated by the following equation, of 45% to 99%:
Upper distribution ratio (%)=(the number of the light-transmitting particles (B) present in a 50% region on a side opposite to the transparent support from a center of the antiglare layer in a thickness direction of the antiglare layer)/(the total number of the light-transmitting particles (B) present in the antiglare layer)×100

2. The antiglare film of claim 1, wherein the upper distribution ratio of the light-transmitting particles (B) is from 70% to 99%.

3. The antiglare film of claim 1, wherein the light-transmitting particles (B) have an average particle diameter of 2.0 μm to 6.0 μm.

4. The antiglare film of claim 1, wherein the light-transmitting particles (B) has a degree of particle aggregation in the antiglare layer, calculated by the following formula, of 1.0 to 2.0:
Degree of particle aggregation=(the total number of the light-transmitting particles (B) present in the antiglare layer in an in-plane direction)/(the number of domains formed by the light-transmitting particles present in the antiglare layer in the in-plane direction)

5. The antiglare film of claim 1, wherein a surface of the antiglare film on a side opposite to the transparent support has a shape having an irregularity waveform measured by a non-contact optical interferometric surface profilomety, wherein an amplitude obtained by analyzing the irregularity waveform by a Fast Fourier transformation is from 0.001 μm to 0.004 μm at a wavelength of 50 μm and 0.001 μm to 0.003 μm at a wavelength of 100 μm.

6. The antiglare film of claim 1, wherein the composition for the antiglare layer further comprises a copolymerization product having an amine value of 1 mgKOH/g to 30 mgKOH/g.

7. The antiglare film of claim 1, wherein the composition for the antiglare layer further comprises an organic polymer thickener.

8. The antiglare film of claim 1, further comprising a low refractive index layer on or above the antiglare layer, the low refractive index layer having a lower refractive index than the antiglare layer.

9. A polarizing plate comprising: a polarizer; and protective films, wherein at least one of the protective films is an antiglare film of claim 1.

10. A polarizing plate comprising: a polarizer; and protective films, wherein one of the protective films is an antiglare film of claim 1 and the other is an optical compensation film having an optical anisotropy.

11. An image display comprising an antiglare film of claim 1 on a display screen thereof.

12. A method for producing an antiglare film of claim 1, the method comprising coating, drying, and curing a composition including the curable resin compound (A) and the light-transmitting particles (B) on the transparent support, to form the antiglare layer.

13. The method of claim 12, wherein the coating and drying of the composition are performed in a state where a normal line of a surface to be coated forms an angle of 0° to 40° relative to a vertically downward direction.

14. The method of claim 12, wherein the composition has a viscosity of 1 mPa·s to 30 mPa·s before the coating of the composition.

15. The method of claim 12, wherein a solid content of the composition becomes 70% or higher by weight within 20 sec after the coating of the composition.

16. The method of claim 12, wherein the composition further comprises two or more solvents, and at least one solvent of the solvents has a boiling point of 80° C. or lower and an amount of the at least one solvent having a boiling point of 80° C. or lower is 30% to 80% by weight based on a total weight of all the solvents.

17. The method of claim 12, wherein the composition has a solid content of 30% to 70% by weight.
